(19) United States
(12) Patent Application Publication
(10) Pub. No.: US 2011/0264480 A1
(43) Pub. Date: Oct. 27, 2011

(54) SYSTEM AND METHOD FOR TASK MANAGEMENT WITH SUB-PORTIONS AND SUB-PORTION CHARACTERISTIC MANIPULATION

(75) Inventors: Calvin R. Gaisford, Orem, UT (US); Boyd H. Timothy, Orem, UT (US)

(73) Assignee: APPIGO, INC., Orem, UT (US)

(21) Appl. No.: 12/768,666

(22) Filed: Apr. 27, 2010

(51) Int. Cl. G06Q 10/00; G06F 3/048

(52) U.S. Cl. 705/7.23; 715/825; 705/301

(57) ABSTRACT

A method and system for providing for the management of resources wherein the method and system provide an ordered collection of projects, tasks, and checklists that may be manipulated and converted between types.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND

Many electronic devices available in the marketplace are aimed at increasing personal productivity. Electronic devices such as personal computers, personal digital assistants, mobile computing devices, mobile telephones and the like are all widely believed to increase personal productivity. The world wide web or the internet is also widely believed to increase personal productivity. These electronic devices and networks have enabled users to receive information instantaneously. While such devices and networks have increased personal productivity, time management is becoming increasingly difficult and important as the number of new electronic devices in the marketplace and ability to receive information instantaneously continues to increase.

As personal productivity and ability to receive information instantaneously increases, so does the need to properly organize and manage projects, tasks and other priorities. Project management methods are often used to help individuals or groups coordinate or share task details and are designed to help a project manager or another individual control a particular project or series of sub-projects. Further, personal productivity software and applications may be used for scheduling, task organization or as a daily organizer or assistant. Personal productivity software and applications may be used for keeping track of individual items or actions needed to complete larger tasks. The disclosure generally relates to time and task management as well as personal productivity and assisting a user in the management of resources.

The features and advantages of the disclosure will be set forth in the description which follows, and in part will be apparent from the description, or may be learned by the practice of the disclosure without undue experimentation. The features and advantages of the disclosure may be realized and obtained by means of the instruments and combinations particularly pointed out in the appended claims.

### SUMMARY

An embodiment may be a method of assisting a user in the management of resources comprising presenting to a user a portion of an ordered collection of data and or records that may comprise at least one of a group of tasks and a group of projects. The tasks may comprise a set of user entries that correspond to a plurality of task data sets stored in machine readable memory. The projects may comprise a set of user entries that correspond to a plurality of project data sets stored in machine readable memory and the projects may comprise tasks therein. The method may further comprise selecting one of the user entries as a selection and then recording and storing the selection in memory. A machine, such as a computer, having a processor may then automatically retrieve a corresponding data set from memory representing one of said user entries and presenting said data set.

An embodiment may be a method of assisting a user in the management of resources comprising presenting to a user a portion of an ordered collection of data and or records that may comprise at least one of a group of tasks and a group of projects. The tasks may comprise a set of user entries that correspond to a plurality of task data sets stored in machine readable memory. The projects may comprise a set of user entries that correspond to a plurality of project data sets stored in machine readable memory and the projects may comprise tasks therein. The method may further comprise selecting one of the user entries as a selection and then recording and storing the selection in memory. A machine, such as a computer, having a processor may then automatically retrieve a corresponding data set from memory representing one of said user entries and presenting said data set to a user or another system for further use and operation. Further, the collection may be a group of user entries representing tasks having various attributes and attribute categories to be assigned.

An embodiment may be a method of assisting a user in the management of resources comprising presenting to a user a portion of an ordered collection of data and or records that may comprise at least one of a group of tasks and a group of projects. The tasks may comprise a set of user entries that correspond to a plurality of task data sets stored in machine readable memory. The projects may comprise a set of user entries that correspond to a plurality of project data sets stored in machine readable memory and the projects may comprise tasks therein. The method may further comprise selecting one of the user entries as a selection and then recording and storing the selection in memory. A machine such as a computer having a processor may then automatically retrieve a corresponding data set from memory representing one of said user entries and presenting said data set to a user or another system for further use and operation. Further, the collection may be a group of user entries representing tasks having various attributes and attribute categories to be assigned. The tasks may comprise sub-tasks that represent individualized portions of said tasks having further refined attributes in functionality and data.

An embodiment may be a method of assisting a user in the management of resources comprising presenting to a user a portion of an ordered collection of data and or records that may comprise at least one of a group of tasks and a group of projects. The tasks may comprise a set of user entries that correspond to a plurality of task data sets stored in machine readable memory. The projects may comprise a set of user entries that correspond to a plurality of project data sets stored in machine readable memory and the projects may comprise tasks therein. The method may further comprise selecting one of the user entries as a selection and then recording and storing the selection in memory. A machine, such as a computer, having a processor may then automatically retrieve a corresponding data set from memory representing one of said user entries and presenting said data set. The collection may further comprise a group of entries representing projects that comprise sub-tasks.

An embodiment may be a method of assisting a user in the management of resources comprising presenting to a user a portion of an ordered collection of data and or records that may comprise at least one of a group of tasks and a group of projects. The tasks may comprise a set of user entries that correspond to a plurality of task data sets stored in machine readable memory. The projects may comprise a set of user entries that correspond to a plurality of project data sets stored in machine readable memory and the projects may comprise tasks therein. The method may further comprise selecting one of the user entries as a selection and then recording and storing the selection in memory. A machine, such as a computer, having a processor may then automatically retrieve a corresponding data set from memory representing one of said user entries and presenting said data set. The collection may further comprise a group of entries representing projects that comprise sub-tasks. The sub-tasks of said projects may have all of the properties and attributes of a task, however, they may be assigned only to a project.

An embodiment may be a method of assisting a user in the management of resources comprising presenting to a user a portion of an ordered collection of data and or records that may comprise at least one of a group of tasks and a group of projects. The tasks may comprise a set of user entries that correspond to a plurality of task data sets stored in machine readable memory. The projects may comprise a set of user entries that correspond to a plurality of project data sets stored in machine readable memory and the projects may comprise tasks therein. The method may further comprise selecting one of the user entries as a selection and then recording and storing the selection in memory. A machine such as a computer having a processor may then automatically retrieve a corresponding data set from memory representing one of said user entries and presenting said data set. The collection may further comprise a group of entries representing projects that comprise sub-tasks and said projects may have characteristics such as: due date, priority, status, start time, due time, alert time and star.

An embodiment may be a method of assisting a user in the management of resources comprising presenting to a user a portion of an ordered collection of data and or records that may comprise at least one of a group of tasks and a group of projects. The tasks may comprise a set of user entries that correspond to a plurality of task data sets stored in machine readable memory. The projects may comprise a set of user entries that correspond to a plurality of project data sets stored in machine readable memory and the projects may comprise tasks therein. The method may further comprise selecting one of the user entries as a selection and then recording and storing the selection in memory. A machine such as a computer having a processor may then automatically retrieve a corresponding data set from memory representing one of said user entries and presenting said data set. The collection may further comprise a group of entries representing projects that comprise sub-tasks and said projects may have characteristics such as: due date, priority, status, start time, due time, alert time and star, such that collection may be organized and presented by any of the characteristics.

An embodiment may be a method of assisting a user in the management of resources comprising presenting to a user a portion of an ordered collection of data and or records that may comprise at least one of a group of tasks and a group of projects. The tasks may comprise a set of user entries that correspond to a plurality of task data sets stored in machine readable memory. The projects may comprise a set of user entries that correspond to a plurality of project data sets stored in machine readable memory and the projects may comprise tasks therein. The method may further comprise selecting one of the user entries as a selection and then recording and storing the selection in memory. A machine, such as a computer, having a processor may then automatically retrieve a corresponding data set from memory representing one of said user entries and presenting said data set. The collection may further comprise a group of entries representing projects that comprise sub-tasks and said projects may have characteristics such as: due date, priority, status, start time, due time, alert time and star. The project may be ordered by its due date or the due date of any of its sub-tasks depending on which is sooner.

An embodiment may be a method of assisting a user in the management of resources comprising presenting to a user a portion of an ordered collection of data and or records that may comprise at least one of a group of tasks and a group of projects. The tasks may comprise a set of user entries that correspond to a plurality of task data sets stored in machine readable memory. The projects may comprise a set of user entries that correspond to a plurality of project data sets stored in machine readable memory and the projects may comprise tasks therein. The method may further comprise selecting one of the user entries as a selection and then recording and storing the selection in memory. A machine, such as a computer, having a processor may then automatically retrieve a corresponding data set from memory representing one of said user entries and presenting said data set. The collection may further comprise a group of entries representing projects that comprise sub-tasks and said projects may have characteristics such as: due date, priority, status, start time, due time, alert time and star. The collection may be organized and presented according to priority.

An embodiment may be a method of assisting a user in the management of resources comprising presenting to a user a portion of an ordered collection of data and or records that may comprise at least one of a group of tasks and a group of projects. The tasks may comprise a set of user entries that correspond to a plurality of task data sets stored in machine readable memory. The projects may comprise a set of user entries that correspond to a plurality of project data sets stored in machine readable memory and the projects may comprise tasks therein. The method may further comprise selecting one of the user entries as a selection and then recording and storing the selection in memory. A machine, such as a computer, having a processor may then automatically retrieve a corresponding data set from memory representing one of said user entries and presenting said data set. The collection may further comprise a group of entries representing projects that comprise sub-tasks and said projects may have characteristics such as: due date, priority, status, start time, due time, alert time and star. The collection may be organized by the priority of the priority assigned to the project by a user or system, or by the priority of any of its sub-tasks depending on which has been given a higher rank.

An embodiment may be a method of assisting a user in the management of resources comprising presenting to a user a portion of an ordered collection of data and or records that may comprise at least one of a group of tasks and a group of projects. The tasks may comprise a set of user entries that correspond to a plurality of task data sets stored in machine readable memory. The projects may comprise a set of user entries that correspond to a plurality of project data sets stored in machine readable memory and the projects may comprise tasks therein. The method may further comprise selecting one of the user entries as a selection and then recording and storing the selection in memory. A machine, such as a computer, having a processor may then automatically retrieve a corresponding data set from memory representing one of said user entries and presenting said data set. The collection may further comprise a group of entries representing projects that comprise sub-tasks. A badge count representing the number of sub-tasks within the project or task may be automatically generated and presented to a user.

An embodiment may be a method of assisting a user in the management of resources comprising presenting to a user a portion of an ordered collection of data and or records that may comprise at least one of a group of tasks and a group of projects. The tasks may comprise a set of user entries that correspond to a plurality of task data sets stored in machine readable memory. The projects may comprise a set of user entries that correspond to a plurality of project data sets stored in machine readable memory and the projects may comprise tasks therein. The method may further comprise selecting one of the user entries as a selection and then recording and storing the selection in memory. A machine, such as a computer, having a processor may then automatically retrieve a corresponding data set from memory representing one of said user entries and presenting said data set. The collection may further comprise a group of entries representing projects that comprise sub-tasks. An overdue badge count of the number of sub-tasks may be automatically generated and presented to a user.

An embodiment may be a method of assisting a user in the management of resources comprising presenting to a user a portion of an ordered collection of data and or records that may comprise at least one of a group of tasks and a group of projects. The tasks may comprise a set of user entries that correspond to a plurality of task data sets stored in machine readable memory. The projects may comprise a set of user entries that correspond to a plurality of project data sets stored in machine readable memory and the projects may comprise tasks therein. The method may further comprise selecting one of the user entries as a selection and then recording and storing the selection in memory. A machine, such as a computer, having a processor may then automatically retrieve a corresponding data set from memory representing one of said user entries and presenting said data set. The collection may further comprise a group of entries representing projects that comprise sub-tasks. A badge count and overdue badge count of the number of sub-tasks within a project is automatically generated and presented to a user.

An embodiment may be a method of assisting a user in the management of resources comprising presenting to a user a portion of an ordered collection of data and or records that may comprise at least one of a group of tasks and a group of projects. The tasks may comprise a set of user entries that correspond to a plurality of task data sets stored in machine readable memory. The projects may comprise a set of user entries that correspond to a plurality of project data sets stored in machine readable memory and the projects may comprise tasks therein. The method may further comprise selecting one of the user entries as a selection and then recording and storing the selection in memory. A machine, such as a computer, having a processor may then automatically retrieve a corresponding data set from memory representing one of said user entries and presenting said data set. The collection may further comprise a group of entries representing projects that comprise sub-tasks. The sub-task count of a project may effect the overall count of tasks in the collection, such that an increase in the number of sub-tasks will increase the overall count of the tasks as presented to a user.

An embodiment may be a method of assisting a user in the management of resources comprising presenting to a user a portion of an ordered collection of data and or records that may comprise at least one of a group of tasks and a group of projects. The tasks may comprise a set of user entries that correspond to a plurality of task data sets stored in machine readable memory. The projects may comprise a set of user entries that correspond to a plurality of project data sets stored in machine readable memory and the projects may comprise tasks therein. The method may further comprise selecting one of the user entries as a selection and then recording and storing the selection in memory. A machine, such as a computer, having a processor may then automatically retrieve a corresponding data set from memory representing one of said user entries and presenting said data set. The collection may further comprise a group of entries representing projects that comprise sub-tasks. The sub-task count of projects may not be used to effect the overall count of tasks in the collection and accordingly will not be presented to a user.

An embodiment may be a method of assisting a user in the management of resources comprising presenting to a user a portion of an ordered collection of data and or records that may comprise at least one of a group of tasks and a group of projects. The tasks may comprise a set of user entries that correspond to a plurality of task data sets stored in machine readable memory. The projects may comprise a set of user entries that correspond to a plurality of project data sets stored in machine readable memory and the projects may comprise tasks therein. The method may further comprise selecting one of the user entries as a selection and then recording and storing the selection in memory. A machine, such as a computer, having a processor may then automatically retrieve a corresponding data set from memory representing one of said user entries and presenting said data set. The collection may further comprise a group of entries representing projects that comprise sub-tasks and at least a checklist having a set of user entries that correspond to a plurality of task data sets stored in machine readable memory. The checklist may comprise checklist sub-tasks therein having attributes and characteristics to work within a checklist scheme.

An embodiment may be a method of assisting a user in the management of resources comprising presenting to a user a portion of an ordered collection of data and or records that may comprise at least one of a group of tasks and a group of projects. The tasks may comprise a set of user entries that correspond to a plurality of task data sets stored in machine readable memory. The projects may comprise a set of user entries that correspond to a plurality of project data sets stored in machine readable memory and the projects may comprise tasks therein. The method may further comprise selecting one of the user entries as a selection and then recording and storing the selection in memory. A machine, such as a computer, having a processor may then automatically retrieve a corresponding data set from memory representing one of said user entries and presenting said data set. The collection may further comprise a group of entries representing projects that comprise sub-tasks and at least a checklist having a set of user entries that correspond to a plurality of task data sets stored in machine readable memory. The checklist may comprise checklist sub-tasks therein having attributes and characteristics to work within a checklist scheme. The characteristics of a checklist sub-tasks may not effect the order of a checklist.

An embodiment may be a method of assisting a user in the management of resources comprising presenting to a user a portion of an ordered collection of data and or records that may comprise at least one of a group of tasks and a group of projects. The tasks may comprise a set of user entries that correspond to a plurality of task data sets stored in machine readable memory. The projects may comprise a set of user entries that correspond to a plurality of project data sets stored in machine readable memory and the projects may comprise tasks therein. The method may further comprise selecting one of the user entries as a selection and then recording and storing the selection in memory. A machine, such as a computer, having a processor may then automatically retrieve a corresponding data set from memory representing one of said user entries and presenting said data set. The collection may further comprise a group of entries representing projects that comprise sub-tasks and at least a checklist having a set of user entries that correspond to a plurality of task data sets stored in machine readable memory. The checklist may comprise checklist sub-tasks therein having attributes and characteristics to work within a checklist scheme. The checklist may present a badge count of how many checklist sub-tasks they contain therein.

An embodiment may be a method of assisting a user in the management of resources comprising presenting to a user a portion of an ordered collection of data and or records that may comprise at least one of a group of tasks and a group of projects. The tasks may comprise a set of user entries that correspond to a plurality of task data sets stored in machine readable memory. The projects may comprise a set of user entries that correspond to a plurality of project data sets stored in machine readable memory and the projects may comprise tasks therein. The method may further comprise selecting one of the user entries as a selection and then recording and storing the selection in memory. A machine, such as a computer, having a processor may then automatically retrieve a corresponding data set from memory representing one of said user entries and presenting said data set. The collection may further comprise a group of entries representing projects that comprise sub-tasks and at least a checklist having a set of user entries that correspond to a plurality of task data sets stored in machine readable memory. The checklist may comprise checklist sub-tasks therein having attributes and characteristics to work within a checklist scheme such as not having due dates.

An embodiment may be a method of assisting a user in the management of resources comprising presenting to a user a portion of an ordered collection of data and or records that may comprise at least one of a group of tasks and a group of projects. The tasks may comprise a set of user entries that correspond to a plurality of task data sets stored in machine readable memory. The projects may comprise a set of user entries that correspond to a plurality of project data sets stored in machine readable memory and the projects may comprise tasks therein. The method may further comprise selecting one of the user entries as a selection and then recording and storing the selection in memory. A machine, such as a computer, having a processor may then automatically retrieve a corresponding data set from memory representing one of said user entries and presenting said data set. The collection may further comprise a group of entries representing projects that comprise sub-tasks and at least a checklist having a set of user entries that correspond to a plurality of task data sets stored in machine readable memory. The checklist may comprise checklist sub-tasks therein having attributes and characteristics to work within a checklist scheme. The checklist may not be configured to have a badge or badge count showing overdue tasks.

An embodiment may be a method of assisting a user in the management of resources comprising presenting to a user a portion of an ordered collection of data and or records that may comprise at least one of a group of tasks and a group of projects. The tasks may comprise a set of user entries that correspond to a plurality of task data sets stored in machine readable memory. The projects may comprise a set of user entries that correspond to a plurality of project data sets stored in machine readable memory and the projects may comprise tasks therein. The method may further comprise selecting one of the user entries as a selection and then recording and storing the selection in memory. A machine, such as a computer, having a processor may then automatically retrieve a corresponding data set from memory representing one of said user entries and presenting said data set. The collection may further comprise a group of entries representing projects that comprise sub-tasks and at least a checklist having a set of user entries that correspond to a plurality of task data sets stored in machine readable memory. The checklist may comprise checklist sub-tasks therein having attributes and characteristics to work within a checklist scheme and wherein any checklist sub-tasks may effect the overall count of tasks in the ordered collection as presented to a user.

An embodiment may be a method of assisting a user in the management of resources comprising presenting to a user a portion of an ordered collection of data and or records that may comprise at least one of a group of tasks and a group of projects. The tasks may comprise a set of user entries that correspond to a plurality of task data sets stored in machine readable memory. The projects may comprise a set of user entries that correspond to a plurality of project data sets stored in machine readable memory and the projects may comprise tasks therein. The ordered collection have a checklist and the checklist comprise a set of user entries that correspond to a plurality of task data sets stored in machine readable memory. The checklist may comprise checklist sub-tasks therein. The method may further comprise selecting one of the user entries as a selection and then recording and storing the selection in memory. A machine, such as a computer, having a processor may then automatically retrieve a corresponding data set from memory representing one of said user entries and presenting said data set. The collection may further comprise a group of entries representing projects that comprise sub-tasks and at least a checklist having a set of user entries that correspond to a plurality of task data sets stored in machine readable memory. The checklist may comprise checklist sub-tasks therein having attributes and characteristics to work within a checklist scheme and wherein any checklist sub-tasks may effect the overall count of tasks in the ordered collection as presented to a user.

An embodiment may be a method of assisting a user in the management of resources comprising presenting to a user a portion of an ordered collection of data and or records that may comprise at least one of a group of tasks and a group of projects. The tasks may comprise a set of user entries that correspond to a plurality of task data sets stored in machine readable memory. The projects may comprise a set of user entries that correspond to a plurality of project data sets stored in machine readable memory and the projects may comprise tasks therein. The method may further comprise selecting one of the user entries as a selection and then recording and storing the selection in memory. A machine, such as a computer, having a processor may then automatically retrieve a corresponding data set from memory representing one of said user entries and presenting said data set. The tasks may be converted into corresponding projects.

An embodiment may be a method of assisting a user in the management of resources comprising presenting to a user a portion of an ordered collection of data and or records that may comprise at least one of a group of tasks and a group of projects. The tasks may comprise a set of user entries that correspond to a plurality of task data sets stored in machine readable memory. The projects may comprise a set of user entries that correspond to a plurality of project data sets stored in machine readable memory and the projects may comprise tasks therein. The method may further comprise selecting one of the user entries as a selection and then recording and storing the selection in memory. A machine, such as a computer, having a processor may then automatically retrieve a corresponding data set from memory representing one of said user entries and presenting said data set. The collection may further comprise a group of entries representing projects that comprise sub-tasks and at least a checklist having a set of user entries that correspond to a plurality of task data sets stored in machine readable memory. The checklist may comprise checklist sub-tasks therein having attributes and characteristics to work within a checklist scheme and wherein tasks are converted into corresponding checklists.

An embodiment may be a method of assisting a user in the management of resources comprising presenting to a user a portion of an ordered collection of data and or records that may comprise at least one of a group of tasks and a group of projects. The tasks may comprise a set of user entries that correspond to a plurality of task data sets stored in machine readable memory. The projects may comprise a set of user entries that correspond to a plurality of project data sets stored in machine readable memory and the projects may comprise tasks therein. The method may further comprise selecting one of the user entries as a selection and then recording and storing the selection in memory. A machine, such as a computer, having a processor may then automatically retrieve a corresponding data set from memory representing one of said user entries and presenting said data set. The projects may be converted into corresponding tasks.

An embodiment may be a method of assisting a user in the management of resources comprising presenting to a user a portion of an ordered collection of data and or records that may comprise at least one of a group of tasks and a group of projects. The tasks may comprise a set of user entries that correspond to a plurality of task data sets stored in machine readable memory. The projects may comprise a set of user entries that correspond to a plurality of project data sets stored in machine readable memory and the projects may comprise tasks therein. The method may further comprise selecting one of the user entries as a selection and then recording and storing the selection in memory. A machine, such as a computer, having a processor may then automatically retrieve a corresponding data set from memory representing one of said user entries and presenting said data set. The collection may further comprise a group of entries representing projects that comprise sub-tasks and at least a checklist having a set of user entries that correspond to a plurality of task data sets stored in machine readable memory. The checklist may comprise checklist sub-tasks therein having attributes and characteristics to work within a checklist scheme and wherein checklists are converted into corresponding tasks.

An embodiment may be a method of assisting a user in the management of resources comprising presenting to a user a portion of an ordered collection of data and or records that may comprise at least one of a group of tasks and a group of projects. The tasks may comprise a set of user entries that correspond to a plurality of task data sets stored in machine readable memory. The projects may comprise a set of user entries that correspond to a plurality of project data sets stored in machine readable memory and the projects may comprise tasks therein. The method may further comprise selecting one of the user entries as a selection and then recording and storing the selection in memory. A machine, such as a computer, having a processor may then automatically retrieve a corresponding data set from memory representing one of said user entries and presenting said data set. The projects may be converted into corresponding tasks by further converting project sub-tasks into corresponding tasks and assigning said tasks into a collection corresponding to said project.

An embodiment may be a method of assisting a user in the management of resources comprising presenting to a user a portion of an ordered collection of data and or records that may comprise at least one of a group of tasks and a group of projects. The tasks may comprise a set of user entries that correspond to a plurality of task data sets stored in machine readable memory. The projects may comprise a set of user entries that correspond to a plurality of project data sets stored in machine readable memory and the projects may comprise tasks therein. The method may further comprise selecting one of the user entries as a selection and then recording and storing the selection in memory. A machine, such as a computer, having a processor may then automatically retrieve a corresponding data set from memory representing one of said user entries and presenting said data set. The collection may further comprise a group of entries representing projects that comprise sub-tasks and at least a checklist having a set of user entries that correspond to a plurality of task data sets stored in machine readable memory. The checklist may comprise checklist sub-tasks therein having attributes and characteristics to work within a checklist scheme and wherein checklists are converted into corresponding tasks and further comprising converting checklist sub-tasks into corresponding tasks and assigning said tasks into a collection corresponding to said checklist.

An embodiment may be a method of assisting a user in the management of resources comprising presenting to a user a portion of an ordered collection of data and or records that may comprise at least one of a group of tasks and a group of projects. The tasks may comprise a set of user entries that correspond to a plurality of task data sets stored in machine readable memory. The projects may comprise a set of user entries that correspond to a plurality of project data sets stored in machine readable memory and the projects may comprise tasks therein. The method may further comprise selecting one of the user entries as a selection and then recording and storing the selection in memory. A machine, such as a computer, having a processor may then automatically retrieve a corresponding data set from memory representing one of said user entries and presenting said data set. The collection may further comprise a group of entries representing projects that comprise sub-tasks and at least a checklist having a set of user entries that correspond to a plurality of task data sets stored in machine readable memory. The checklist may comprise checklist sub-tasks therein having attributes and characteristics to work within a checklist scheme and wherein checklists are converted into corresponding tasks and wherein checklist sub-tasks inherit default values when converted to sub-tasks.

An embodiment may be a method of assisting a user in the management of resources comprising presenting to a user a portion of an ordered collection of data and or records that may comprise at least one of a group of tasks and a group of projects. The tasks may comprise a set of user entries that correspond to a plurality of task data sets stored in machine readable memory. The projects may comprise a set of user entries that correspond to a plurality of project data sets stored in machine readable memory and the projects may comprise tasks therein. The method may further comprise selecting one of the user entries as a selection and then recording and storing the selection in memory. A machine, such as a computer, having a processor may then automatically retrieve a corresponding data set from memory representing one of said user entries and presenting said data set. The tasks may be converted into corresponding projects and wherein tasks that are converted to sub-tasks in a project are assigned to said project.

An embodiment may be a method of assisting a user in the management of resources comprising presenting to a user a portion of an ordered collection of data and or records that may comprise at least one of a group of tasks and a group of projects. The tasks may comprise a set of user entries that correspond to a plurality of task data sets stored in machine readable memory. The projects may comprise a set of user entries that correspond to a plurality of project data sets stored in machine readable memory and the projects may comprise tasks therein. The method may further comprise selecting one of the user entries as a selection and then recording and storing the selection in memory. A machine, such as a computer, having a processor may then automatically retrieve a corresponding data set from memory representing one of said user entries and presenting said data set. The collection may further comprise a group of entries representing projects that comprise sub-tasks and at least a checklist having a set of user entries that correspond to a plurality of task data sets stored in machine readable memory. The checklist may comprise checklist sub-tasks therein having attributes and characteristics to work within a checklist scheme and wherein checklists are converted into corresponding tasks and wherein tasks that are converted to sub-tasks in a checklist are assigned to said checklist.

An embodiment may be a method of assisting a user in the management of resources comprising presenting to a user a portion of an ordered collection of data and or records that may comprise at least one of a group of tasks and a group of projects. The tasks may comprise a set of user entries that correspond to a plurality of task data sets stored in machine readable memory. The projects may comprise a set of user entries that correspond to a plurality of project data sets stored in machine readable memory and the projects may comprise tasks therein. The method may further comprise selecting one of the user entries as a selection and then recording and storing the selection in memory. A machine, such as a computer, having a processor may then automatically retrieve a corresponding data set from memory representing one of said user entries and presenting said data set. The tasks may be converted into corresponding projects and wherein converted sub-tasks from a project are removed from the project to which it was assigned.

An embodiment may be a method of assisting a user in the management of resources comprising presenting to a user a portion of an ordered collection of data and or records that may comprise at least one of a group of tasks and a group of projects. The tasks may comprise a set of user entries that correspond to a plurality of task data sets stored in machine readable memory. The projects may comprise a set of user entries that correspond to a plurality of project data sets stored in machine readable memory and the projects may comprise tasks therein. The method may further comprise selecting one of the user entries as a selection and then recording and storing the selection in memory. A machine, such as a computer, having a processor may then automatically retrieve a corresponding data set from memory representing one of said user entries and presenting said data set. The collection may further comprise a group of entries representing projects that comprise sub-tasks and at least a checklist having a set of user entries that correspond to a plurality of task data sets stored in machine readable memory. The checklist may comprise checklist sub-tasks therein having attributes and characteristics to work within a checklist scheme and wherein checklists are converted into corresponding tasks and wherein converted checklist sub-tasks from a checklist are removed from said checklist to which it was assigned.

An embodiment may be a method of assisting a user in the management of resources comprising presenting to a user a portion of an ordered collection of data and or records that may comprise at least one of a group of tasks and a group of projects. The tasks may comprise a set of user entries that correspond to a plurality of task data sets stored in machine readable memory. The projects may comprise a set of user entries that correspond to a plurality of project data sets stored in machine readable memory and the projects may comprise tasks therein. The method may further comprise selecting one of the user entries as a selection and then recording and storing the selection in memory. A machine, such as a computer, having a processor may then automatically retrieve a corresponding data set from memory representing one of said user entries and presenting said data set. The collection may further comprise a group of entries representing projects that comprise sub-tasks and at least a checklist having a set of user entries that correspond to a plurality of task data sets stored in machine readable memory. Wherein the method further comprises converting a checklist into a project wherein checklist sub-tasks are converted into corresponding tasks and sub-tasks within a project. The checklist may comprise checklist sub-tasks therein having attributes and characteristics to work within a checklist scheme and wherein checklists are converted into corresponding tasks and wherein converted checklist sub-tasks from a checklist are removed from said checklist to which it was assigned.

An embodiment may be a method of assisting a user in the management of resources comprising presenting to a user a portion of an ordered collection of data and or records that may comprise at least one of a group of tasks and a group of projects. The tasks may comprise a set of user entries that correspond to a plurality of task data sets stored in machine readable memory. The projects may comprise a set of user entries that correspond to a plurality of project data sets stored in machine readable memory and the projects may comprise tasks therein. The method may further comprise selecting one of the user entries as a selection and then recording and storing the selection in memory. A machine, such as a computer, having a processor may then automatically retrieve a corresponding data set from memory representing one of said user entries and presenting said data set. The collection may further comprise a group of entries representing projects that comprise sub-tasks and at least a checklist having a set of user entries that correspond to a plurality of task data sets stored in machine readable memory. Wherein the method further comprises converting a checklist into a project wherein checklist sub-tasks are converted into corresponding tasks and sub-tasks within a project. The checklist may comprise checklist sub-tasks therein having attributes and characteristics to work within a checklist scheme and wherein checklists are converted into corresponding tasks and wherein converted checklist sub-tasks from a checklist are removed from said checklist to which it was assigned. The method may further comprise place holding values that may be automatically assigned to attributes of tasks and sub-tasks, once converted from checklist sub-tasks to tasks and sub-tasks within a project.

An embodiment may be a method of assisting a user in the management of resources comprising presenting to a user a portion of an ordered collection of data and or records that may comprise at least one of a group of tasks and a group of projects. The tasks may comprise a set of user entries that correspond to a plurality of task data sets stored in machine readable memory. The projects may comprise a set of user entries that correspond to a plurality of project data sets stored in machine readable memory and the projects may comprise tasks therein. The method may further comprise selecting one of the user entries as a selection and then recording and storing the selection in memory. A machine, such as a computer, having a processor may then automatically retrieve a corresponding data set from memory representing one of said user entries and presenting said data set. The collection may further comprise a group of entries representing projects that comprise sub-tasks and at least a checklist having a set of user entries that correspond to a plurality of task data sets stored in machine readable memory. Wherein the method further comprises converting a project into a checklist, wherein project tasks and sub-tasks are converted into corresponding tasks and sub-tasks within a checklist.

An embodiment may be a method of assisting a user in the management of resources comprising presenting to a user a portion of an ordered collection of data and or records that may comprise at least one of a group of tasks and a group of projects. The tasks may comprise a set of user entries that correspond to a plurality of task data sets stored in machine readable memory. The projects may comprise a set of user entries that correspond to a plurality of project data sets stored in machine readable memory and the projects may comprise tasks therein. The method may further comprise selecting one of the user entries as a selection and then recording and storing the selection in memory. A machine, such as a computer, having a processor may then automatically retrieve a corresponding data set from memory representing one of said user entries and presenting said data set. The collection may further comprise a group of entries representing projects that comprise sub-tasks and at least a checklist having a set of user entries that correspond to a plurality of task data sets stored in machine readable memory. Wherein the method further comprises converting a project into a checklist, wherein project tasks and sub-tasks are converted into corresponding tasks and sub-tasks within a checklist and wherein attribute data is discarded during the conversion of project tasks and sub-tasks into checklist tasks and sub-tasks.

### BRIEF DESCRIPTION OF THE DRAWINGS

The features and advantages of the disclosure will become apparent from a consideration of the subsequent detailed description presented in connection with the accompanying drawings in which:

FIG. 1 illustrates a system for performing a method of providing task management with sub-portions in accordance with the disclosure;

FIG. 2 illustrates a schematic representation of a project in accordance with the disclosure;

FIG. 3 illustrates a schematic representation of a project in accordance with the disclosure having sub-portions and attributes;

FIG. 4 illustrates a schematic representation of a task in accordance with the disclosure;

FIG. 5 illustrates a schematic representation of a task in accordance with the disclosure having sub-portions and attributes;

FIG. 6 illustrates a schematic representation of a checklist in accordance with the disclosure;

FIG. 7 illustrates a schematic representation of a checklist in accordance with the disclosure having sub-portions and attributes;

FIG. 8 illustrates a schematic representation of an ordered collection in accordance with the disclosure having sub-portions and attributes;

FIGS. 9-17 illustrate an embodiment of a method of assisting a user in the management of resources in accordance with the disclosure;

FIGS. 18-20 illustrate an embodiment of a method of assisting a user in the management of resources in accordance with the disclosure;

FIG. 21 illustrates a conversion between a task and a project in accordance with the disclosure;

FIG. 22 illustrates a conversion between a checklist and a project in accordance with the disclosure;

FIG. 22A illustrates a conversion between a checklist and a task in accordance with the disclosure;

FIG. 23 illustrates a conversion between a task into sub-tasks and then assigned to a project in accordance with the disclosure; and

FIG. 24 illustrates a conversion from a checklist and project into tasks in accordance with the disclosure.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

Before the systems and methods for managing time and productivity are disclosed and described, it is to be understood that this disclosure is not limited to the particular configurations and process steps disclosed herein as such configurations and process steps may vary somewhat. It is also to be understood that the terminology employed herein is used for the purpose of describing particular embodiments only and is not intended to be limiting since the scope of the disclosure will be limited only by the appended claims and equivalents thereof.

In describing and claiming the subject matter of the disclosure, the following terminology will be used in accordance with the definitions set out below.

It must be noted that, as used in this specification and the appended claims, the singular forms “a,” “an,” and “the” include plural referents unless the context clearly dictates otherwise.

As used herein, the terms “comprising,” “including,” “containing,” “characterized by,” and grammatical equivalents thereof are inclusive or open-ended terms that do not exclude additional, unrecited elements or method steps.

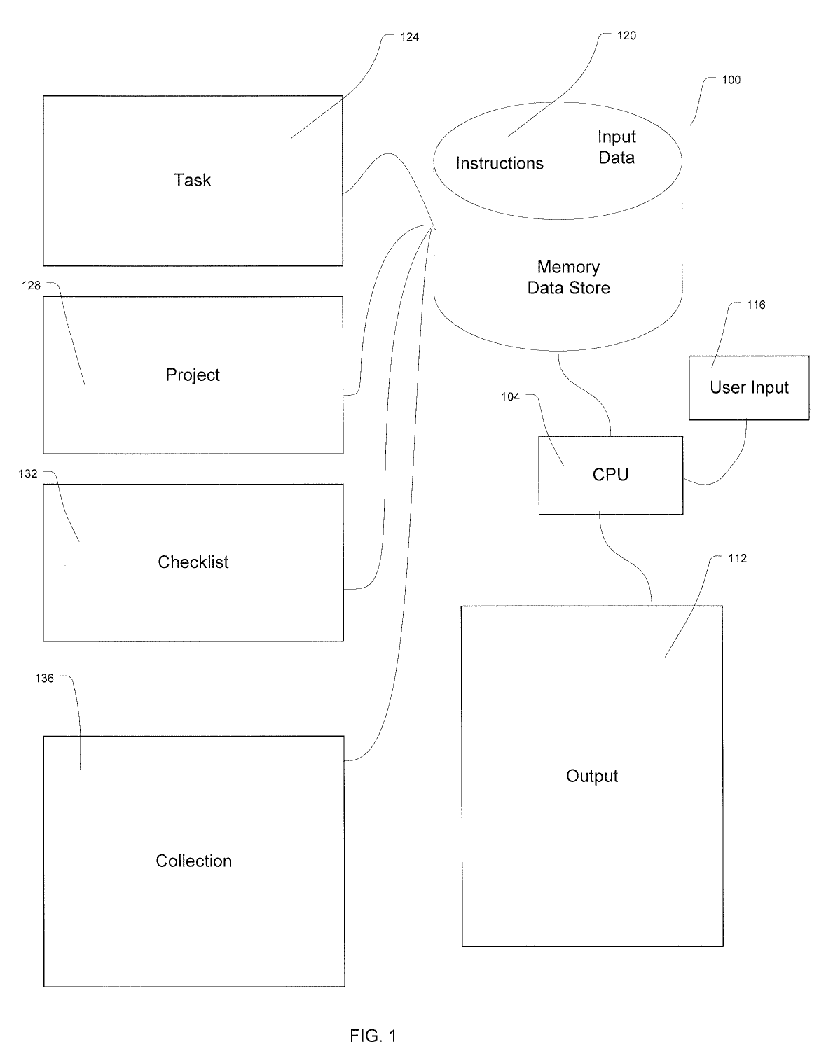

FIG. 1 illustrates a system for performing the method of providing task management with sub-portions. The system 100 may comprise a machine, such as a computer, capable of performing and executing instructions of a method read from memory or storage. The system 100 may provide a task management method to a user or may provide the task management method to another machine for further refinement and use. The system 100 may output and receive inputs from the user in accordance to the instructions of the method of the disclosure. The system 100 may comprise various computing components for executing the method. One such component may be a CPU 104 for processing data from memory 108 to outputting data to an output 112. The output 112 may be an electronic display for perception by a user or it may be a data port to another system. Another component may be an input 116. The input 116 may be configured for receiving instructions and selections by a user. The input 116 may be configured for receiving data from another system, such as a computer or network, thereby allowing the method to be used with other methods and systems. The system 100 may further comprise memory 120 or a data storage means, wherein the memory 120 may comprise instructions for operating the system in accordance with the disclosure. The memory 120 may provide a means for storing data such as task and sub-task data. The memory 120 may provide a means for storing user input data, such as instructions and selections made by a user. The memory 120 may work with the CPU 104 for storing intermediate method steps for performing the methods disclosed herein. The memory 120 may be a plurality of memory or storage modules.

The memory 120 may comprise task data 124 and associated sub-task data. The memory 120 may comprise project data 128 and associated sub-task data. The memory 120 may comprise checklist data 132 and associated checklist sub-task data. The memory 120 may comprise collection data 136, wherein said collection data 136 may comprise task data 124 and associated sub-task data, project data 128 and associated sub-task data and checklist data 132 and associated sub-task data. The CPU 104 may be employed to retrieve from memory 120 and record to memory 120 data of the above mentioned types.

In use, the CPU 104 will initiate system 100 and receive instructions from memory 120 for performing the method in accordance with the disclosure. The CPU 104 may then cause an output 112 to be created. The output 112 may comprise a representation of the collection data 132, wherein the collection data 132 may comprise items such as entries made by a user that represent tasks, projects, and checklists. The tasks, projects and checklists may be derived from corresponding data stored in memory 120. A user may then enter an instruction or make a selection through the input 116. The selection made through input 116 may then be stored in memory. Based on the user selection or entry, collection data 136 may be manipulated and conveyed through the output 112. The CPU 104 may cause that data from task data 124, project data 128 and checklist data 132 be integrated or transformed into collection data 136. In other words, task data 124 representing a real world task or errand to be performed may be used to form collection data 136; project data 126 representing a real world project to be completed by a user may be used to form collection data 136; and checklist data 132 representing a real world checklist of items or tasks to be completed by a user, may be used to form collection data 136. The collection data 136 may then be used to form and output 112. The output 112 may be a visual display, and said visual display may be configured for receiving user inputs, such as touch screen display. It will be appreciated that other outputs beside a visual display may be used without departing from the scope of the disclosure, such that the disclosure is not limited to visual displays. By repeating the steps above and in coordination with operation of the system 100 task management may be performed.

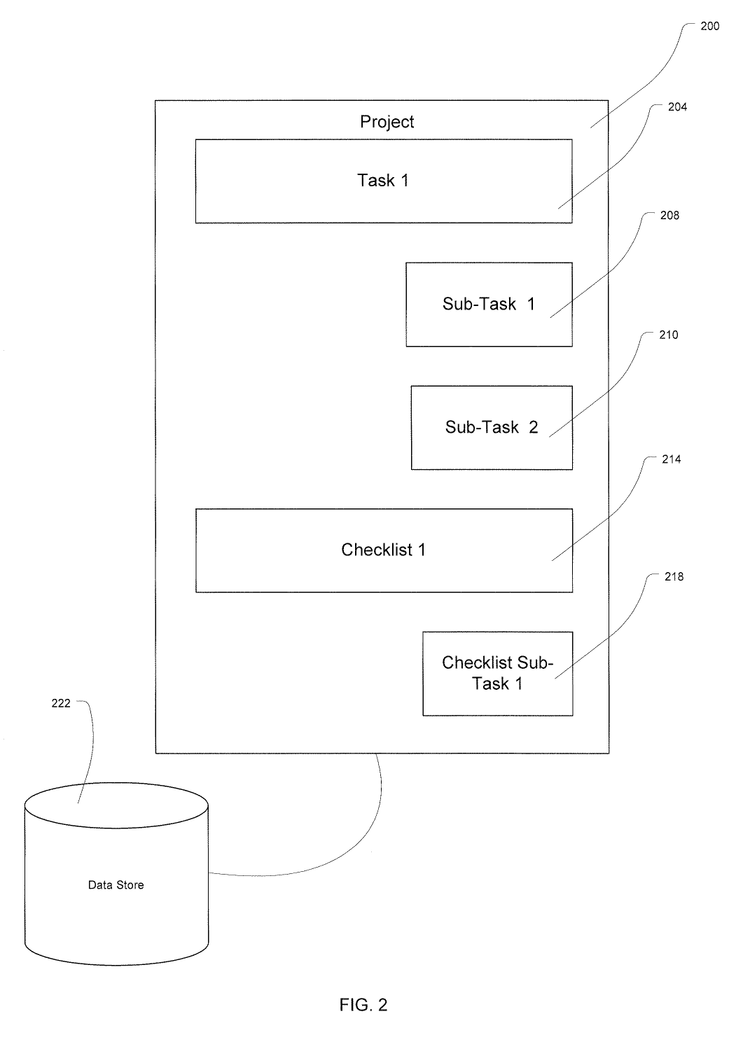

FIG. 2 illustrates a schematic representation of a project in accordance with the disclosure. A project 200 may comprise task 204 having sub-task 208 and sub-task 210. A project 200 may comprise a checklist 214 having checklist sub-task 218. The task 204 may be stored in the form of data in memory 222. The task data is representative of a real world task or errand to be completed by a user. As discussed above, a user may input an entry representing and describing a task to be performed that is stored in memory 222. The task 204 may comprise a sub-task 208 that represents portion of the task 204 that needs to be performed. Sub-task data may be stored in memory 222 and may be given attribute data that corresponds to the task to which it is subordinate. The checklist 214 may comprise checklist sub-tasks 218 that may be stored as data and corresponds to the checklist to which it is subordinate. Thus, a project may be made up of a series of tasks and checklists that represent real world items or errands to be completed. A project may allow a user to organize many related tasks and checklists into a single project, with each of the tasks and checklist, along with their sub-portions, to be managed under a single project. Data tags may be applied to the data representing the sub-portions of the project in order to allow a system to keep the sub-portions associated with the project to which they belong.

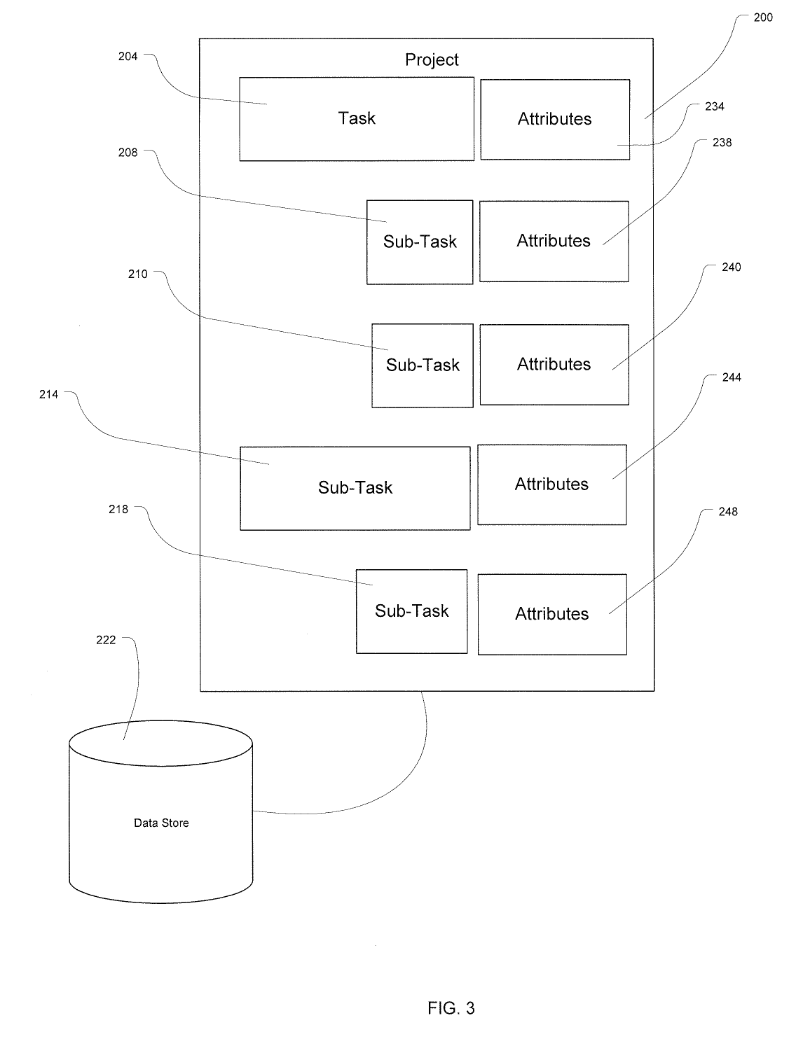

FIG. 3 illustrates a schematic representation of a project in accordance with the disclosure having sub-portions and attributes. A project 200 may comprise task 204 having sub-task 208 and sub-task 210, having attributes 234, 238, 240 assigned to them in order to maintain ordered relationships. A project 200 may comprise a checklist 214 having checklist sub-task 218, which have attributes 244, 248 assigned to them in order to maintain ordered relationships. The task 204 and its attributes 234 may be stored in the form of data in memory 222. The task data is representative of a real world task or errand to be completed by a user. As discussed above, a user may input an entry representing and describing a task to be performed that is stored in memory 222. The task 204 may comprise a sub-task 208 that represents a portion of the task 204 that needs to be performed. Sub-task data and its attributes 238 may be stored in memory 222. The checklist 214 and its attributes 244 may comprise checklist sub-tasks 218 and their attributes 248 that may be stored as data and corresponds to the checklist to which it is subordinate. Thus, a project may be made up of a series of tasks and checklists having cohesive attributes assigned thereto that represent real world items or errands to be completed. A project may allow a user to organize many related tasks and checklists into a single project, with each of the tasks and checklists, along with their sub-portions, to be managed under a single project. Attributes may be applied to the data representing the sub-portions of the project in order to allow a system to keep the sub-portions associated with the project to which they belong.

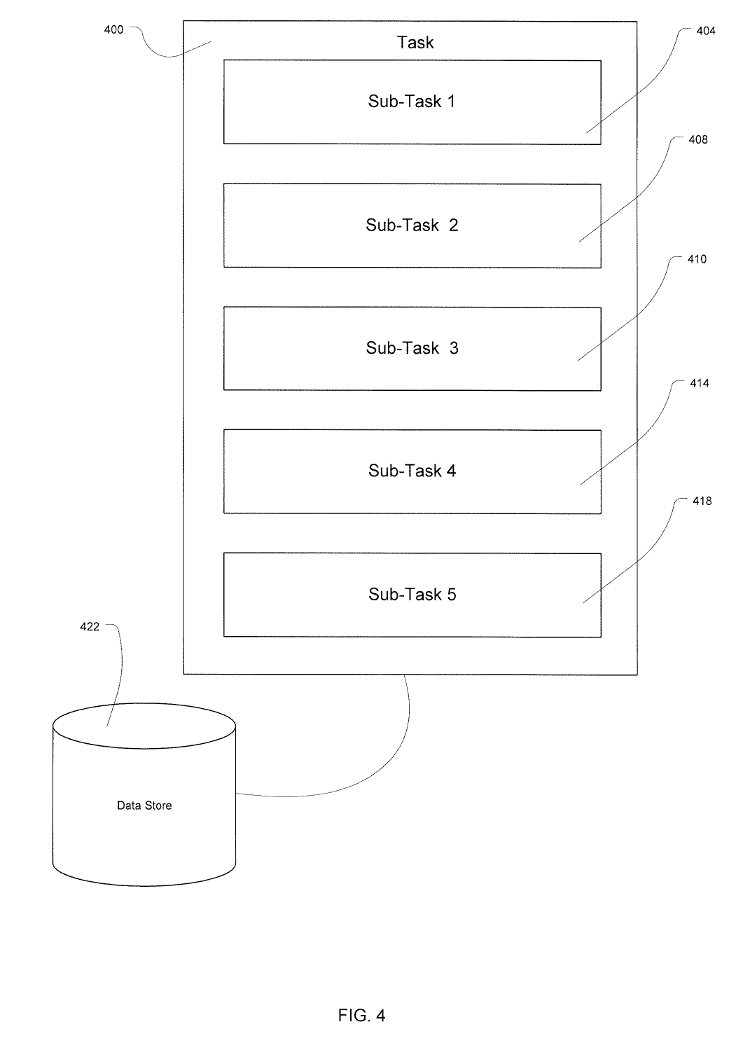

FIG. 4 illustrates a schematic representation of a task in accordance with the disclosure. A task 400 may comprise sub-tasks, such as sub-task 404, sub-task 408, sub-task 410, sub-task 414, and sub-task 418. The sub-task 404 may be stored in the form of data in memory 422. The task data is representative of a real world task or errand to be completed by a user. As discussed above, a user may input an entry representing and describing a task to be performed that is stored in memory 422. The task 400 may comprise a sub-task 408 that represents a portion of the task 400 that needs to be performed. Sub-task data may be stored in memory 422 and may be given attribute data that corresponds to the task to which it is subordinate. Thus, a task may be made up of a series of sub-tasks that represent real world items or errands to be completed. A task may allow a user to organize many related sub-tasks into a single task, with each of the sub-tasks, along with their sub-portions, to be managed under a single task. Data tags may be applied to the data representing the sub-portions of the task in order to allow a system to keep the sub-portions associated with the task to which they belong.

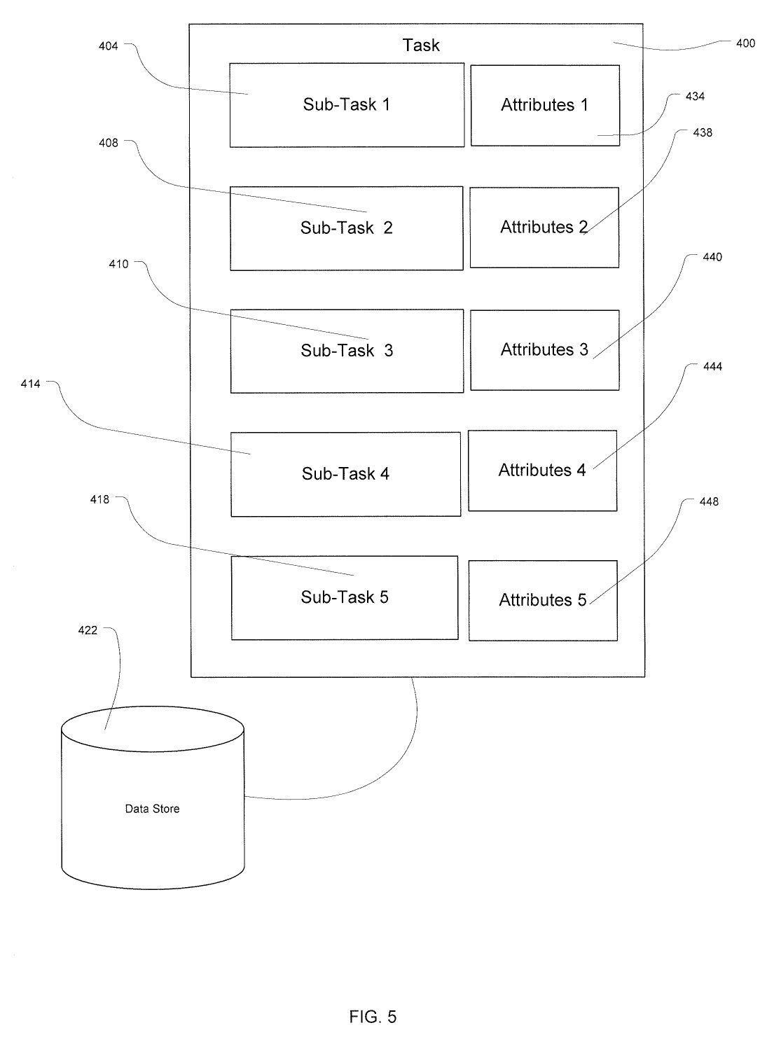

FIG. 5 illustrates a schematic representation of a task in accordance with the disclosure having sub-portions and attributes. A task 400 may comprise sub-tasks 404, 408, 410, 414, 418, having attributes 434, 438, 440, 444, 448 assigned to them in order to maintain ordered relationships. The task 400 and its sub-portions may be stored in the form of data in memory 422. The task data is representative of a real world task or errand to be completed by a user. As discussed above, a user may input an entry representing and describing a task to be performed that is stored in memory 422. The task 400 may comprise a sub-task 408 that represents a portion of the task 400 that needs to be performed. Sub-task data and its attributes may be stored in memory 422. Therefore, a task may be made up of a series of sub-tasks having cohesive attributes assigned thereto that represent real world items or errands to be completed. A task may allow a user to organize many related sub-tasks into a single task, with each of the sub-tasks or sub-portions to be managed under a single task. Attributes may be applied to the data representing the sub-portions of the task in order to allow a system to keep the sub-portions associated with the project to which they belong.

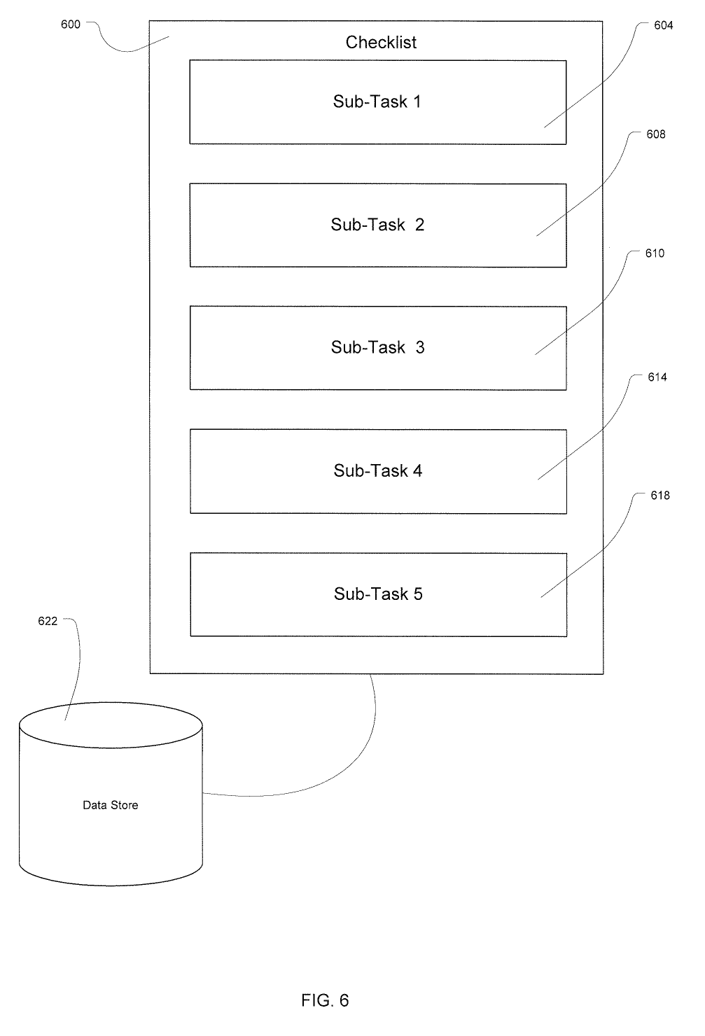

FIG. 6 illustrates a schematic representation of a checklist in accordance with the disclosure. A checklist 600 may comprise sub-tasks such as sub-task 604, sub-task 608, sub-task 610, sub-task 614 and sub-task 618. A sub-task in a checklist may be limited in the attributes or characteristics it may be assigned. Such a limited sub-task may be referred to as a checklist sub-task. A checklist sub-task may have characteristics limited only to: due date and priority. The sub-task 604 may be stored in the form of data in memory 622. The checklist data is representative of a real world task or errand to be completed by a user. As discussed above, a user may input an entry representing and describing a task to be performed that is stored in memory 622. The checklist 600 may comprise a sub-task 608 that represents a portion of the checklist 600 that needs to be performed. Sub-task data may be stored in memory 622 and may be given attribute data that corresponds to the checklist to which it is subordinate. Thus, a checklist may be made up of a series of sub-tasks that represent real world items or errands to be completed. A checklist may allow a user to organize many related sub-tasks into a single checklist, with each of the sub-tasks, along with their sub-portions, to be managed under a single checklist. Data tags may be applied to the data representing the sub-portions of the checklist in order to allow a system to keep the sub-portions associated with the checklist to which they belong.

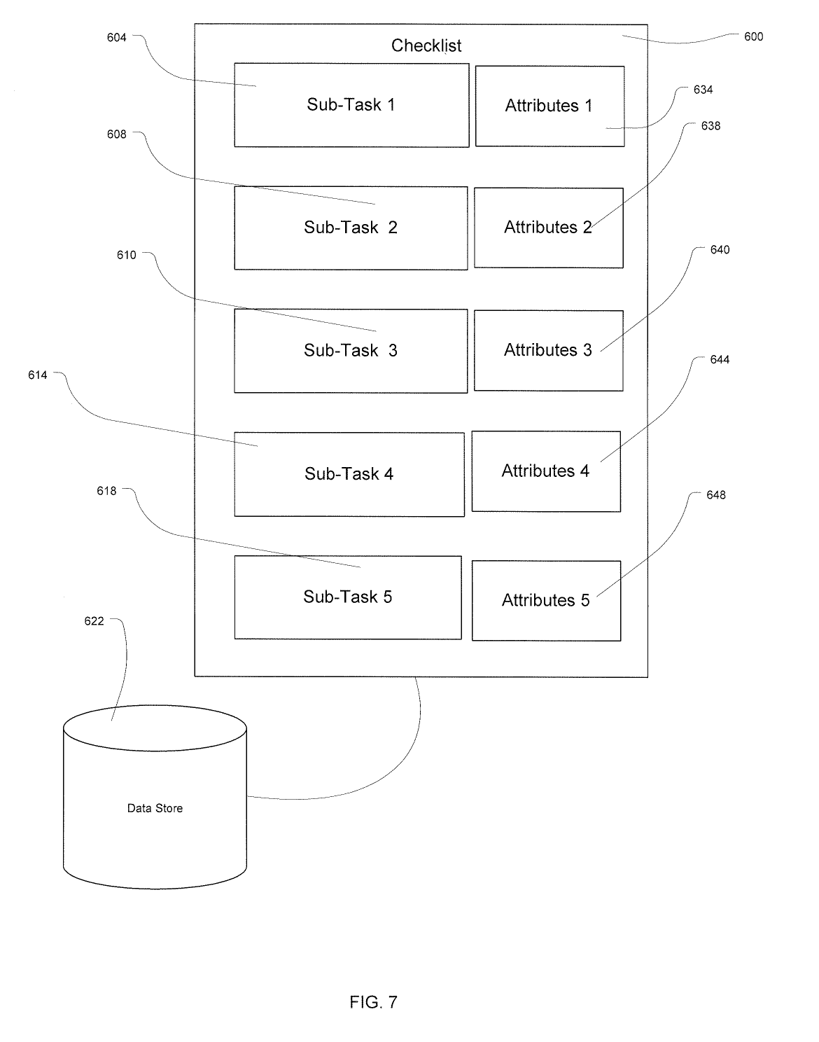

FIG. 7 illustrates a schematic representation of a checklist in accordance with the disclosure having sub-portions and attributes. A checklist 600 may comprise sub-tasks 604, 608, 610, 614, 618, having attributes 634, 638, 640, 644, 648 assigned to them in order to maintain ordered relationships. The checklist 600 and its sub-portions may be stored in the form of data in memory 622. The checklist data is representative of real world tasks, items or errands to be completed by a user. As discussed above, a user may input an entry representing and describing a checklist to be performed that is stored in memory 622. The checklist 600 may comprise a sub-task 608 that represents a portion of the checklist 600 that needs to be performed. Sub-task data and its attributes may be stored in memory 622. Therefore, a checklist may be made up of a series of sub-tasks having cohesive attributes assigned thereto that represent real world items or errands to be completed. A checklist may allow a user to organize many related sub-tasks into a single checklist, with each of the sub-tasks or sub-portions to be managed under a single task. Attributes may be applied to the data representing the sub-portions of the task in order to allow a system to keep the sub-portions associated with the project to which they belong.

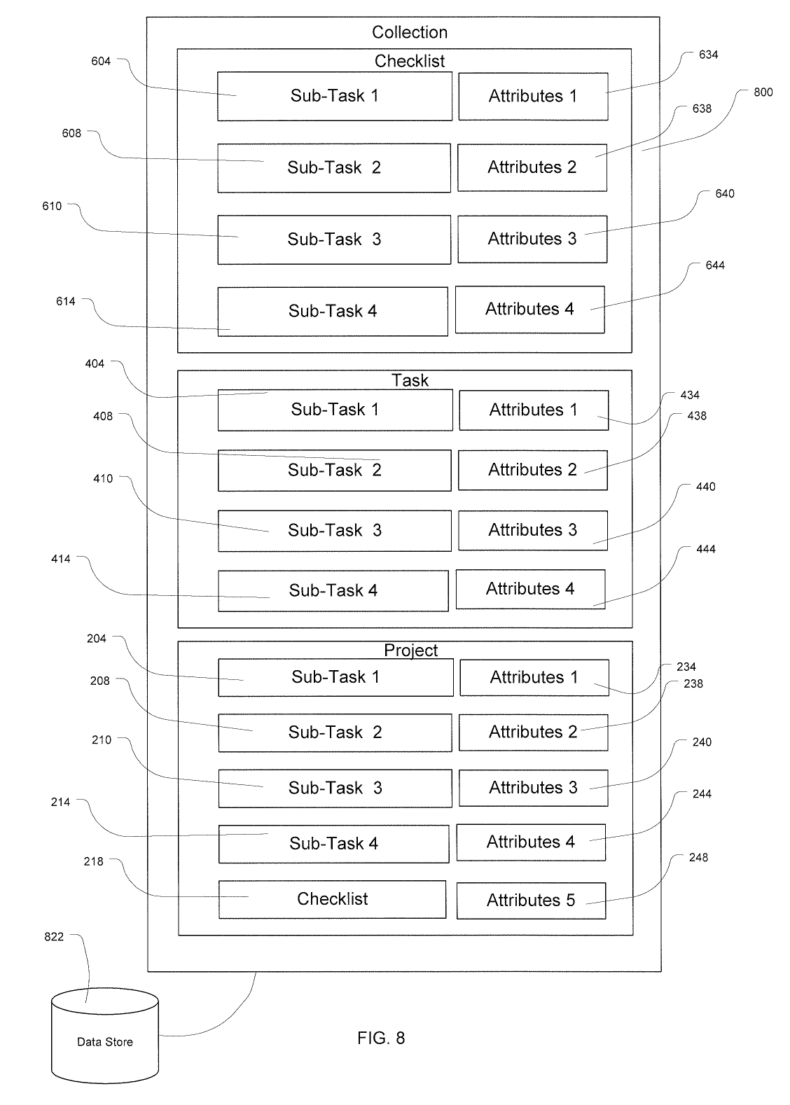

FIG. 8 illustrates a schematic representation of an ordered collection in accordance with the disclosure having sub-portions and attributes. An ordered collection 800 may comprise a project 200, a checklist 600, and a task 400 as discussed above. A project 200 may comprise tasks 204 having sub-task 208 and sub-task 210, having attributes 234, 238, 240 assigned to them in order to maintain ordered relationships. A project 200 may comprise a checklist 214 having checklist sub-task 218, having attributes 244, 248 assigned to them in order to maintain ordered relationships. The task 204 and its attributes 234 may be stored in the form of data in memory 822. The task data is representative of a real world tasks and errands to be completed by a user. As discussed above, a user may input an entry representing and describing a task to be performed that is stored in memory 822. The task 204 may comprise a sub-task 208 that represents a portion of the task 204 that needs to be performed. Sub-task data and its attributes 238 may be stored in memory 822. The checklist 214 and its attributes 244 may comprise checklist sub-tasks 218 and their attributes 248 that may be stored as data and corresponds to the checklist to which it is subordinate. Thus, a project may be made up of a series of tasks and checklists having cohesive attributes assigned thereto that represent real world items or errands to be completed. A project may allow a user to organize many related tasks and checklists into a single project, with each of the tasks and checklists, along with their sub-portions to be managed under a single project. Attributes may be applied to the data representing the sub-portions of the project in order to allow a system to keep the sub-portions associated with the project to which they belong.

A task 400 may comprise sub-tasks 404, 408, 410, 414, 418, having attributes 434, 438, 440, 444, 448 assigned to them in order to maintain ordered relationships. The task 400 and its sub-portions may be stored in the form of data in memory 822. The task data is representative of a real world task, item or errand to be completed by a user. As discussed above, a user may input an entry representing and describing a task to be performed that is stored in memory 422. The task 400 may comprise a sub-task 408 that represents a portion of the task 400 that needs to be performed. Sub-task data and its attributes may be stored in memory 822. Thus, a task may be made up of a series of sub-tasks having cohesive attributes assigned thereto that represent real world items or errands to be completed. A task may allow a user to organize many related sub-tasks into a single task, with each of the sub-tasks or sub-portions to be managed under a single task. Attributes may be applied to the data representing the sub-portions of the task in order to allow a system to keep the sub-portions associated with the project to which they belong.

A checklist 600 may comprise sub-tasks 604, 608, 610, 614, 618, having attributes 634, 638, 640, 644, 648 assigned to them in order to maintain ordered relationships. The checklist 600 and its sub-portions may be stored in the form of data in memory 822. The checklist data is representative of a real world tasks, items or errands to be completed by a user. As discussed above, a user may input an entry representing and describing a checklist to be performed that is stored in memory 822. The checklist 600 may comprise a sub-task 608 that represents a portion of the checklist 600 that needs to be performed. Sub-task data and its attributes may be stored in memory 822. Thus, a checklist may be made up of a series of sub-tasks having cohesive attributes assigned thereto that represent real world items or errands to be completed. A checklist may allow a user to organize many related sub-tasks into a single checklist, with each of the sub-tasks or sub-portions to be managed under a single task. Attributes may be applied to the data representing the sub-portions of the task in order to allow a system to keep the sub-portions associated with the project to which they belong.

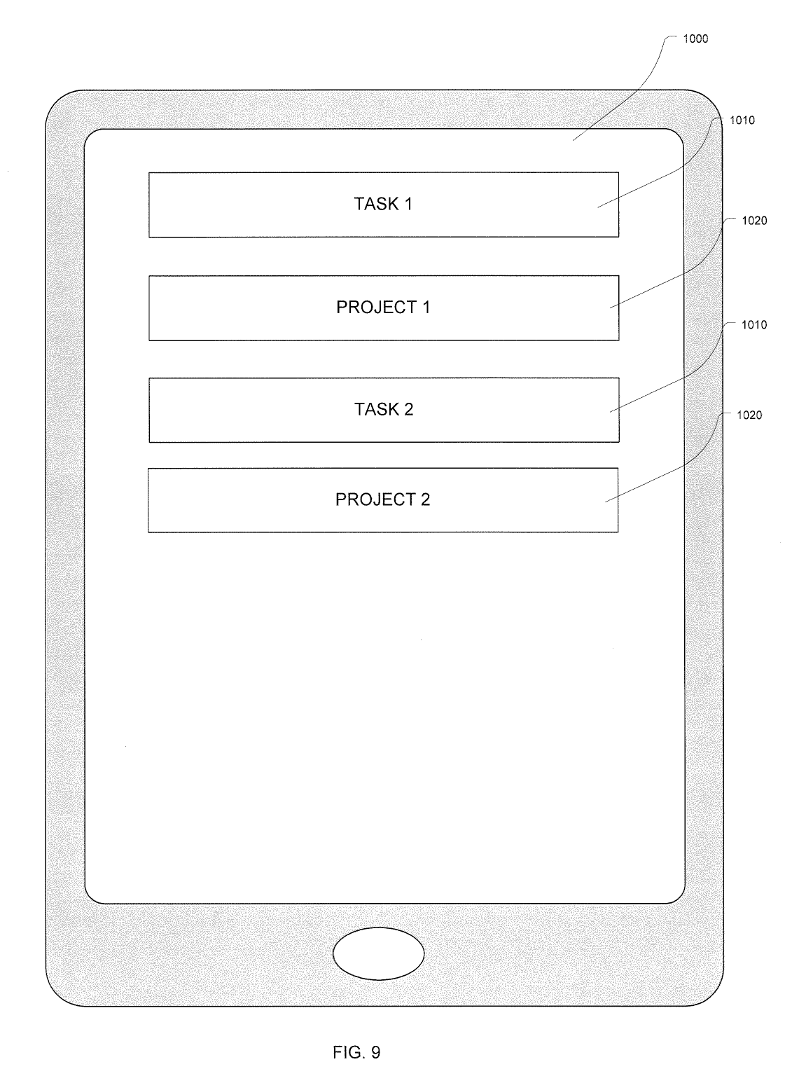

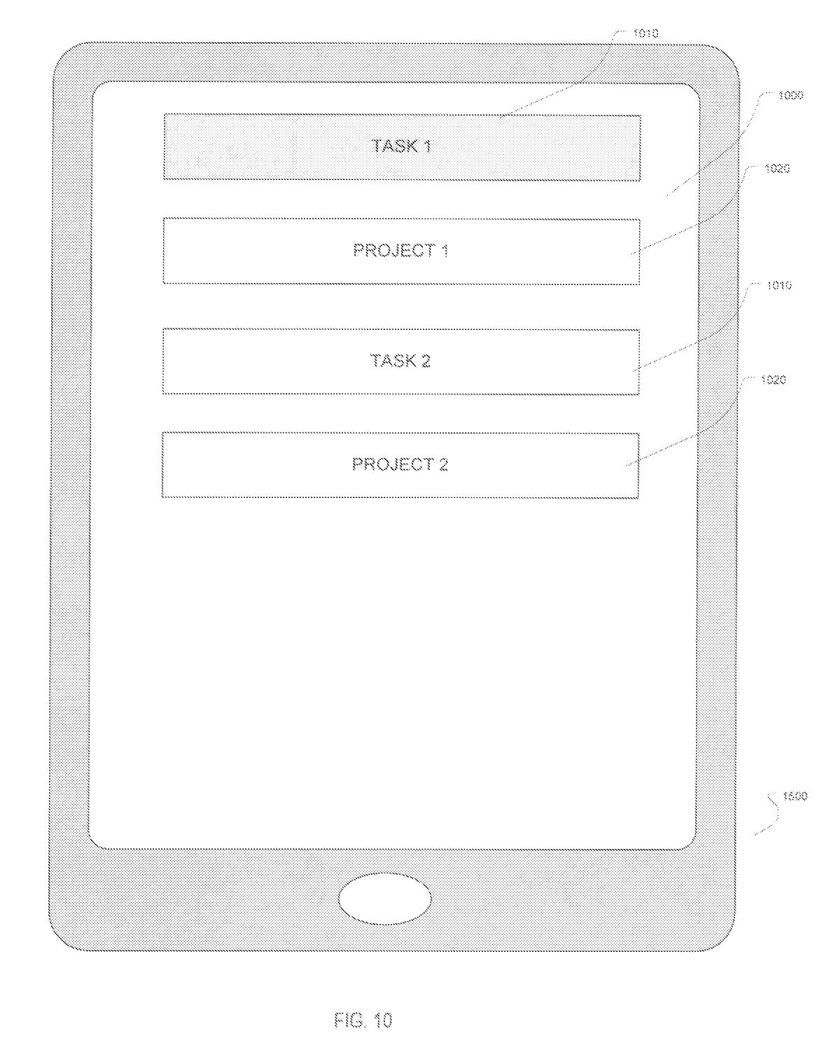

FIGS. 9-17 illustrate an embodiment of a method of assisting a user in the management of resources. This embodiment will be discussed with reference to figures depicting a mobile device, however, the scope of the method as disclosed herein is not intended to be limited to mobile devices. Thus, computing devices or other devices comprising a processor and memory, whether mobile or not, may be utilized by the disclosure. The embodiment may comprise: presenting to a user a portion of an ordered collection 1000 of data and or records that may comprise at least one of a group of tasks 1010 and a group of projects 1020. The tasks 1010 may comprise a set of user entries that correspond to a plurality of task data sets stored in machine readable memory. The projects 1020 may comprise a set of user entries that correspond to a plurality of project data sets stored in machine readable memory and the projects may comprise tasks therein.

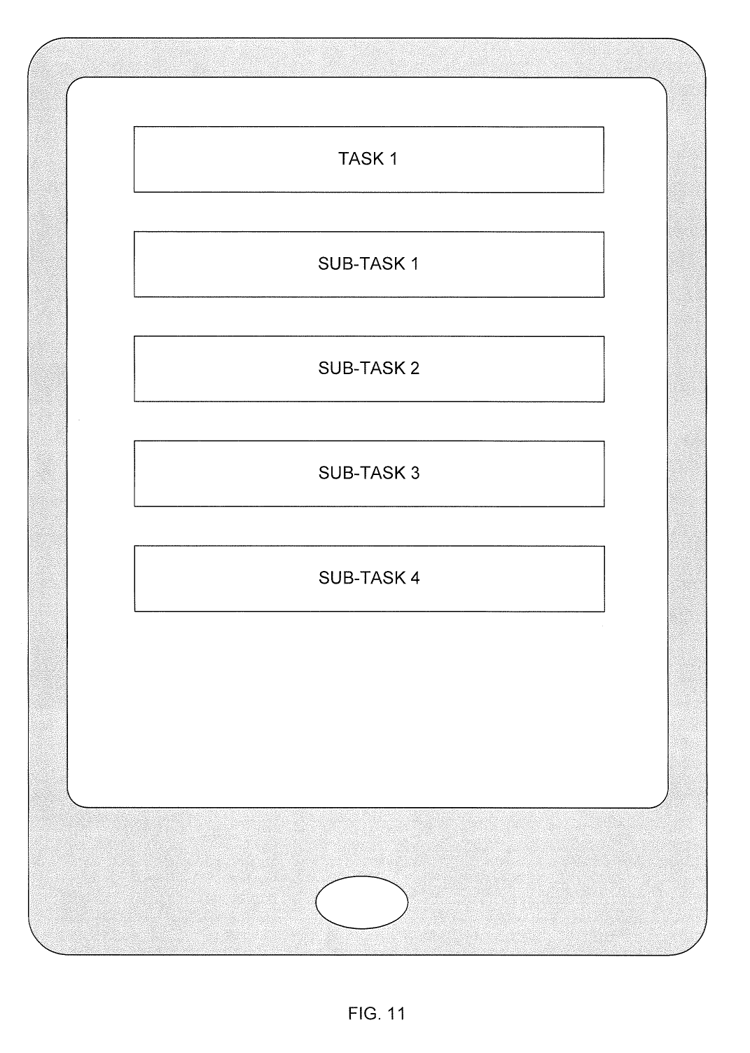

As seen in FIG. 10, the method may further comprise: selecting one of the user entries as a selection and then recording and storing the selection in memory. As seen in FIG. 10, TASK 1 has been selected by a user. A machine 1500, such as a computer having a processor, may then automatically retrieve a corresponding data set from memory representing one of said user entries and presenting said data set.

Data retrieved from memory may represent attributes of TASK 1 and those attributes and characteristics will be presented, as seen in FIG. 11. Because TASK 1 was selected by a user, attribute data associated with TASK 1 will be presented to a user. As discussed above, tasks may comprise sub-portions or sub-tasks, representing real items or errands that a user should accomplish in order to complete the overall task. In the illustrated embodiment, TASK 1 comprises SUB-TASKS 1-4.

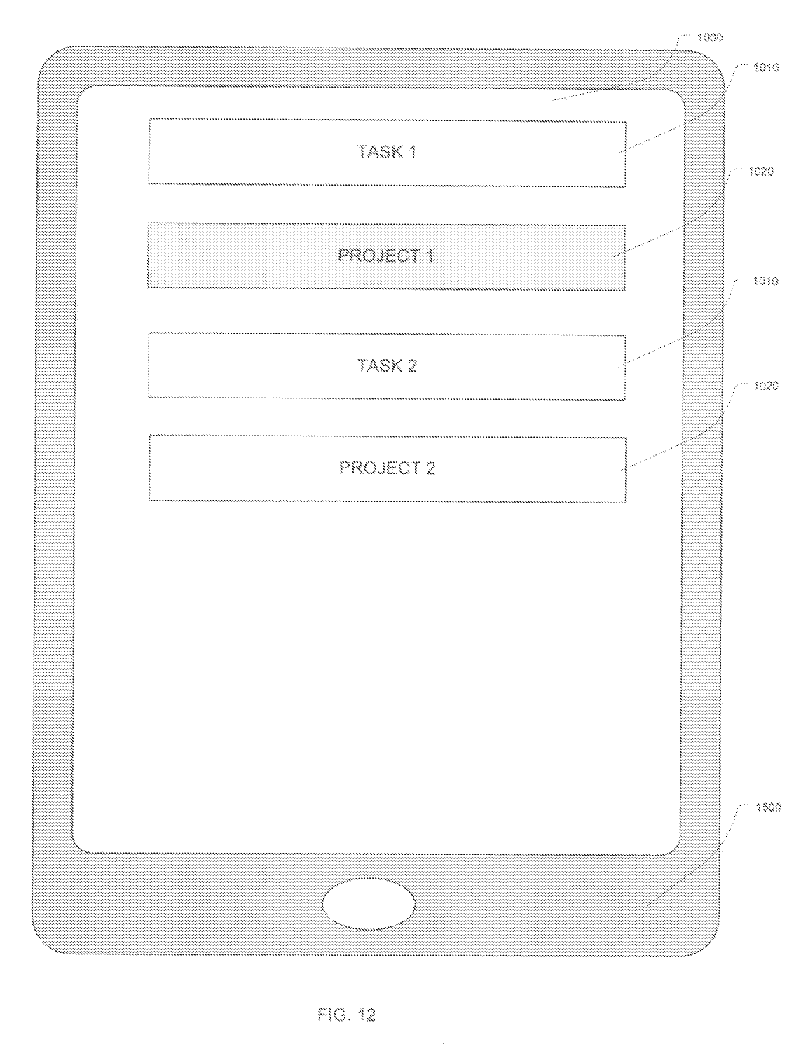

As seen in FIG. 12, the method may further comprise: selecting one of the user entries as a selection and then recording and storing the selection in memory. As seen in FIG. 12, PROJECT 1 has been selected by a user. A machine 1500, such as a computer having a processor, may then automatically retrieve a corresponding data set from memory representing one of said user entries and presenting said data set.

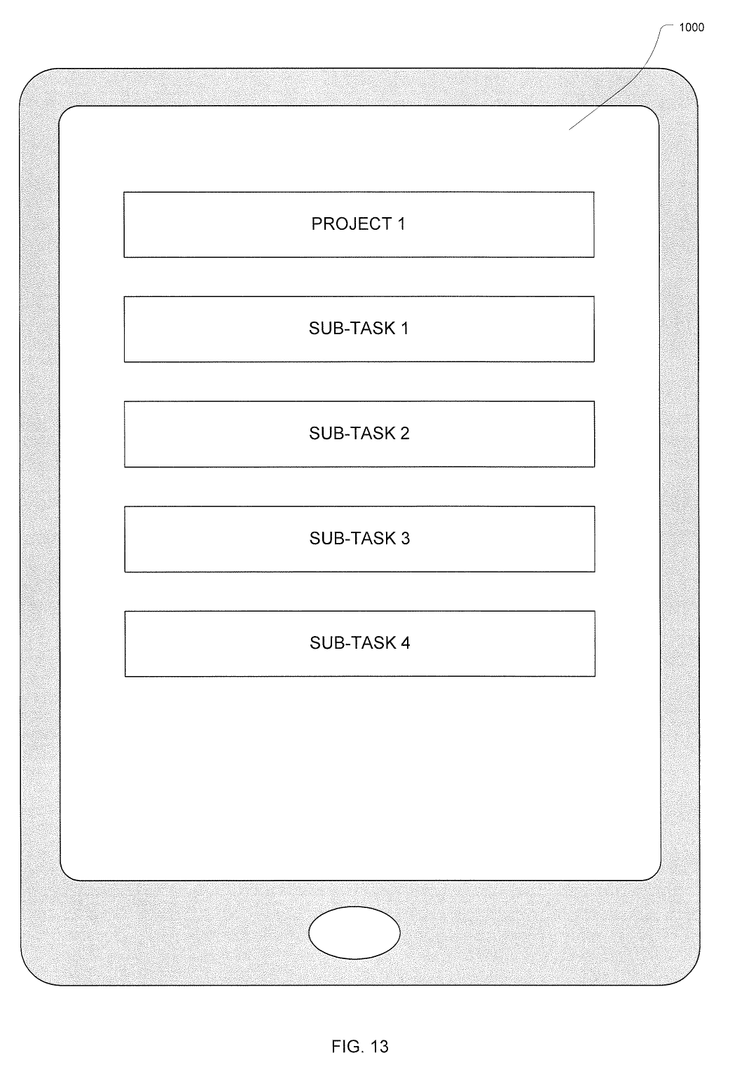

Data retrieved from memory may represent attributes of PROJECT 1 and those attributes and characteristics will be presented, as seen in FIG. 13. Because PROJECT 1 was selected by a user, attribute data associated with PROJECT 1 will be presented to a user. As discussed above, projects may comprise sub-portions or sub-tasks, representing real world items or errands that a user should accomplish in order to complete the overall project. In the illustrated embodiment, PROJECT 1 comprises SUB-TASKS 1-4.

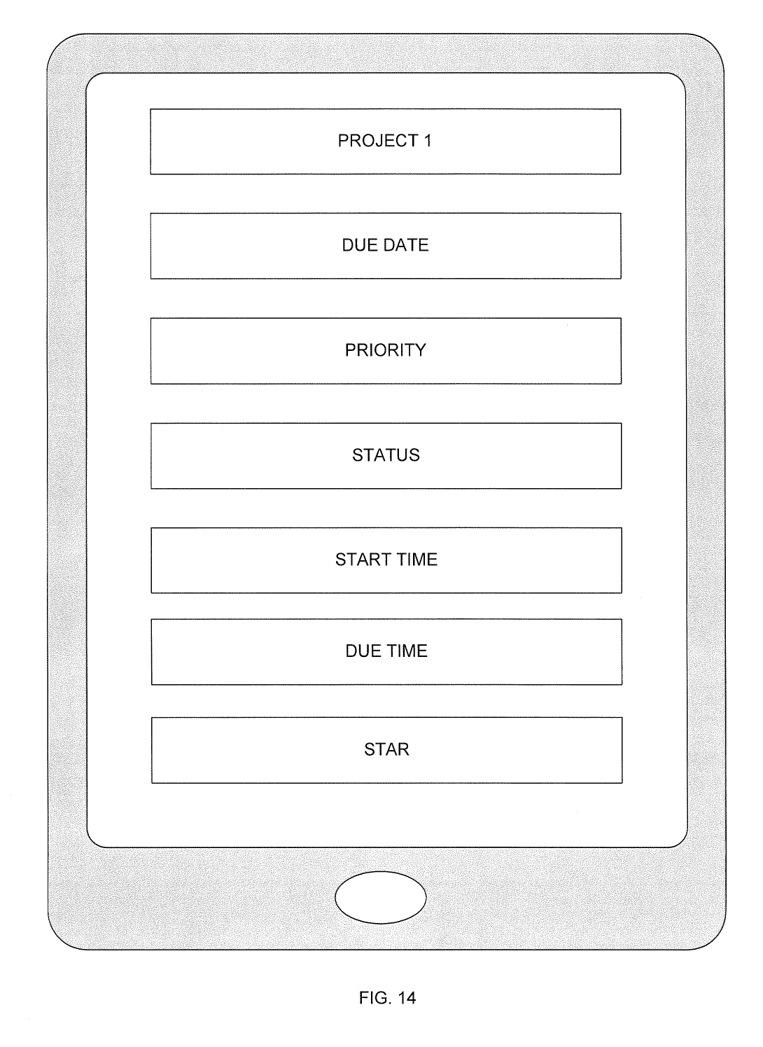

FIG. 14 illustrates various attributes that a project or task may have. Because PROJECT 1 has been selected by a user, the attribute data of PROJECT 1 will be presented. Attributes may comprise: due date data, priority data, status data, start time data, due time data, alert time data and star data. Each of these attributes may be defined by a user, or may be assigned automatically by the method. Values for the attributes are written into memory and stored for use.

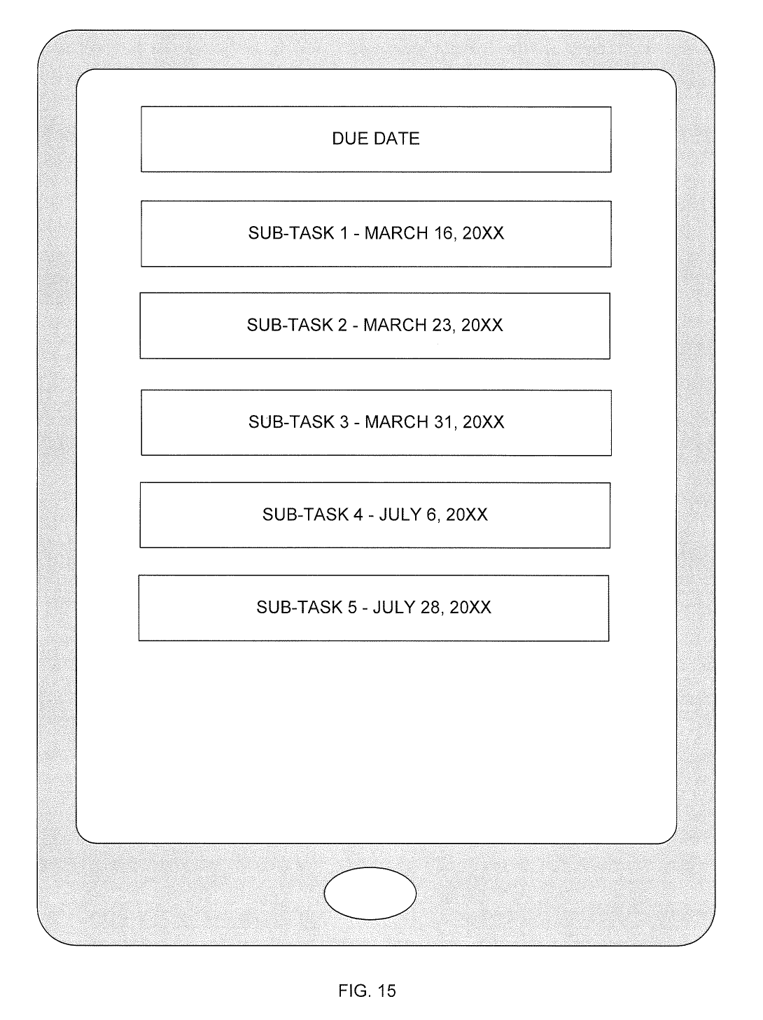

FIG. 15 illustrates how attributes or characteristics may be used to order the collection of the method. An attribute that may control the ordering of the collection may be the date tasks or sub-tasks are due. As seen in FIG. 15, SUB-TASKS 1-5 have been presented by their due date attributes.

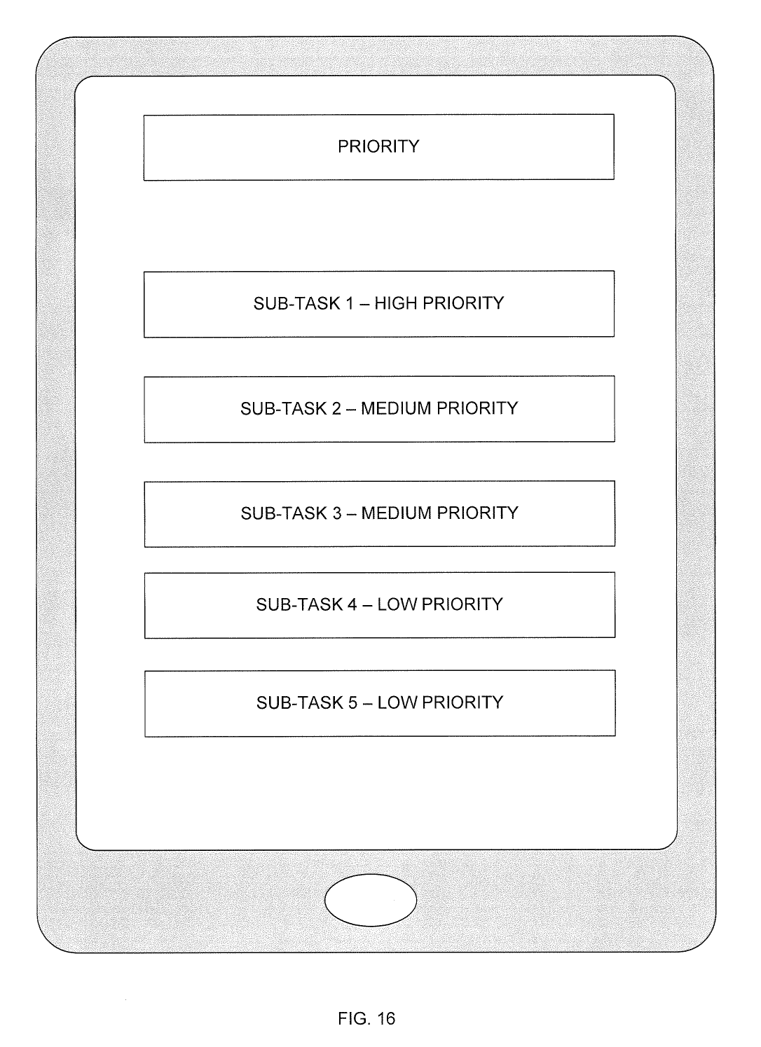

FIG. 16 illustrates how attributes or characteristics may be used to order the collection of the method. An attribute that may control the ordering of the collection may be the priority tasks or sub-tasks are assigned. As seen in FIG. 16, SUB-TASKS 1-5 have been presented by their priority attributes.

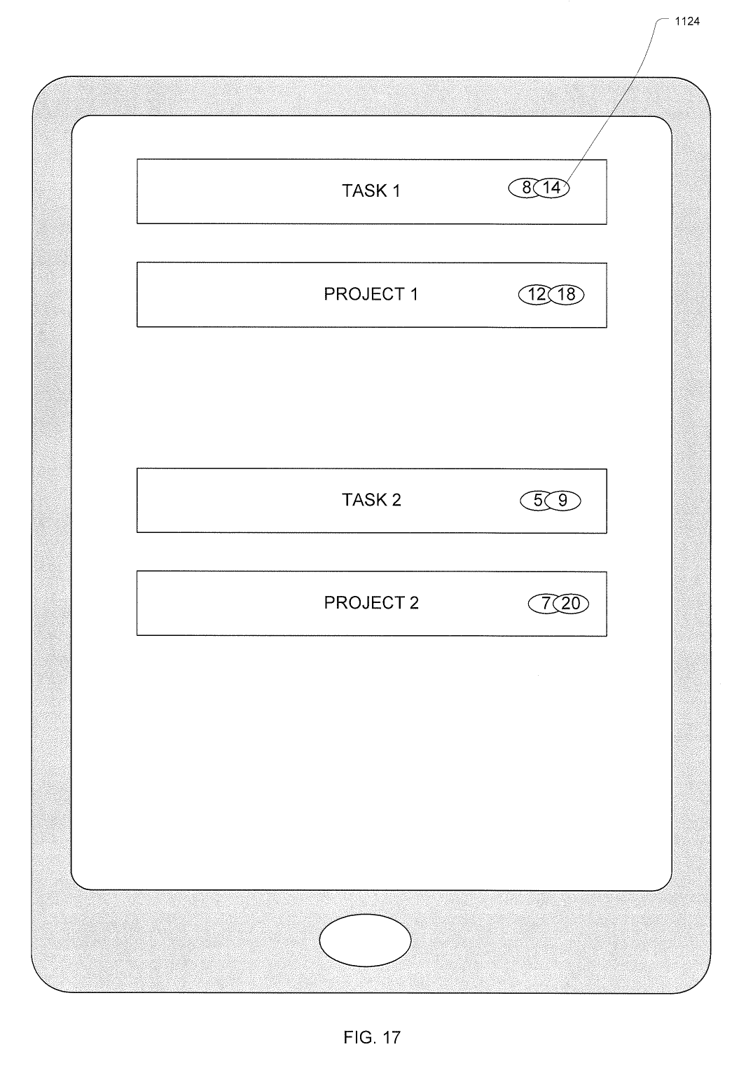

FIG. 17 illustrates an embodiment wherein a badge count 1124, which may represent the number of sub-tasks in a project or task, is automatically generated and presented to a user. A badge count may be a count of the number of sub-tasks associated with a project or task needed to complete the project or task. A badge count 1124 may comprise a plurality of portions. A portion may be dedicated to present the number of overdue sub-tasks within the task or project.

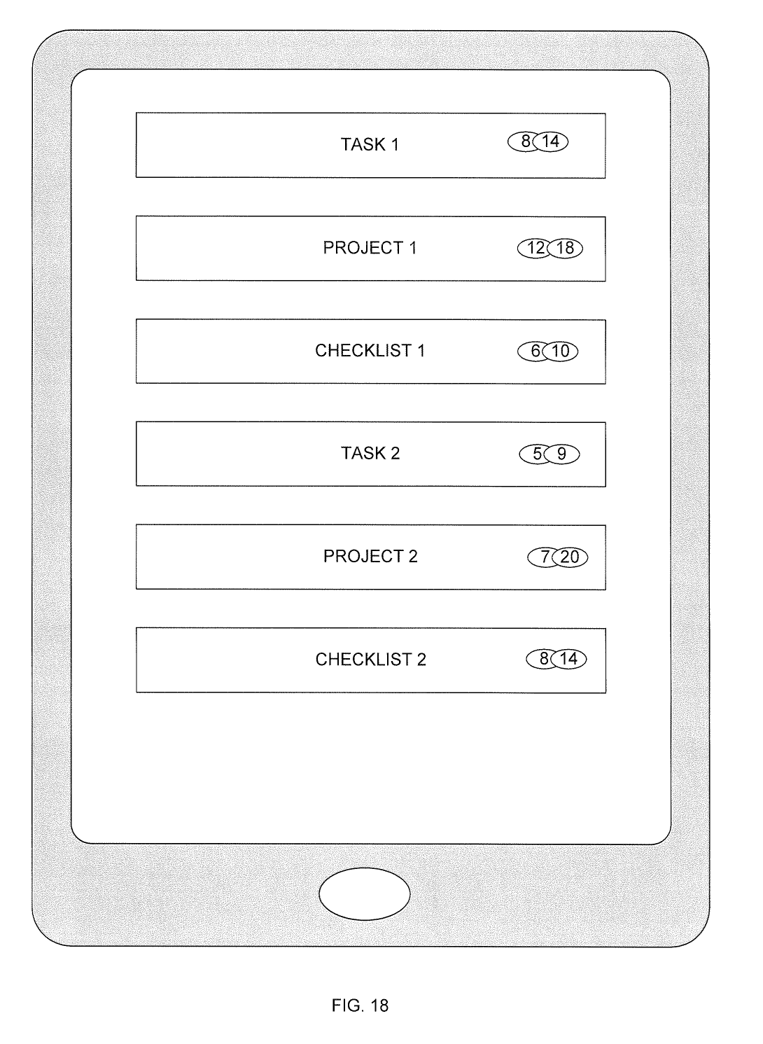

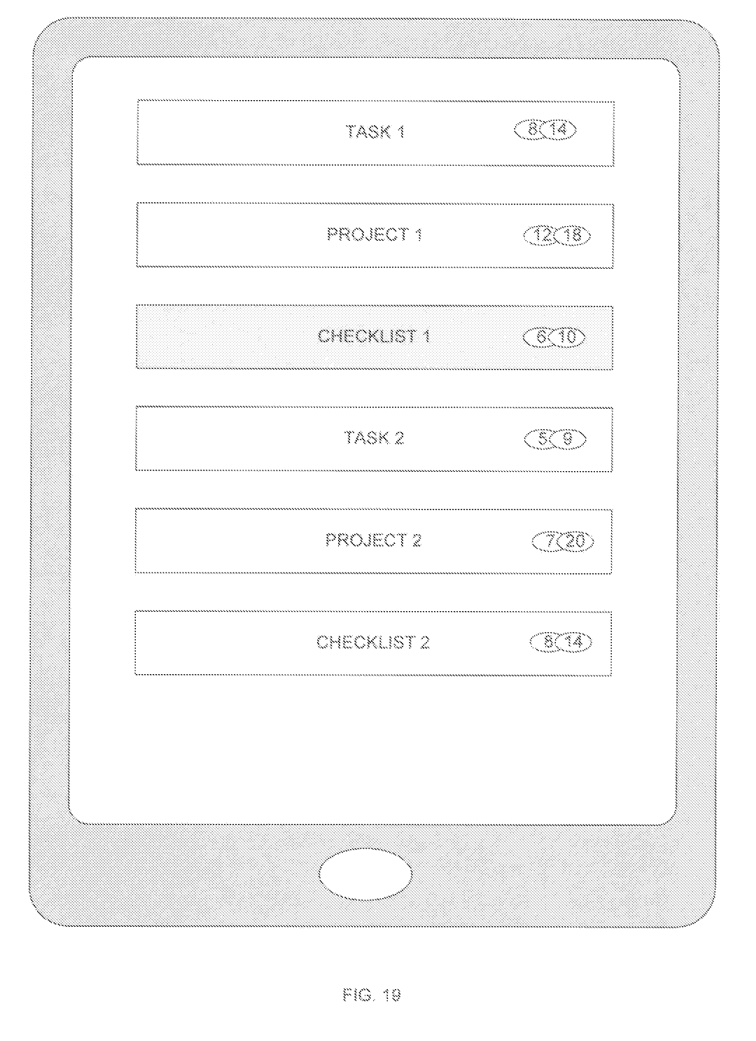

FIGS. 18-20 illustrate an embodiment of a method of assisting a user in the management of resources. This embodiment will be discussed with reference to figures depicting a mobile device, however the scope of the method as disclosed herein is not intended to be limited to mobile devices. Thus, computing devices or other devices comprising a processor and memory, whether mobile or not, may be utilized by the disclosure. The embodiment may comprise: presenting to a user a portion of an ordered collection of data and or records that may comprise at least one of a group of tasks, a group of projects, and a group of checklists. The tasks may comprise a set of user entries that correspond to a plurality of task data sets stored in machine readable memory. The projects may comprise a set of user entries that correspond to a plurality of project data sets stored in machine readable memory and the projects may comprise tasks therein. The checklists may comprise a set of user entries that correspond to a plurality of checklist data sets stored in machine readable memory.

As seen in FIG. 19, the method may further comprise: selecting one of the user entries as a selection and then recording and storing the selection in memory. As seen in FIG. 19, CHECKLIST 1 has been selected by a user. A machine, such as a computer having a processor, may then automatically retrieve a corresponding data set from memory representing one of said user entries and presenting said data set.

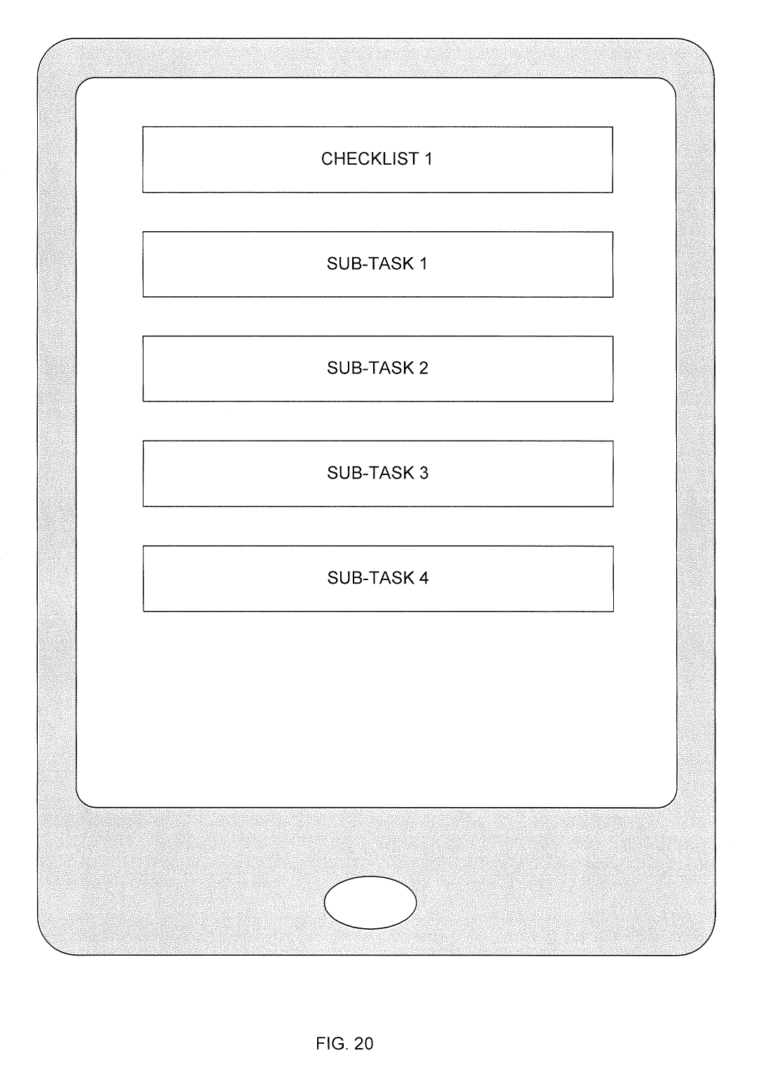

Data retrieved from memory may represent attributes of CHECKLIST 1 and those attributes and characteristics will be presented, as seen in FIG. 20. Because CHECKLIST 1 was selected by a user, attribute data associated with CHECKLIST 1 will be presented to a user. As discussed above, checklists may comprise sub-portions or sub-tasks, representing real world items or errands that a user should accomplish in order to complete the overall checklist. A checklist may comprise sub-tasks, having attributes assigned to them in order to maintain ordered relationships. The checklist and its sub-portions may be stored in the form of data in memory. The checklist data is representative of a real world tasks, items or errands to be completed by a user. As discussed above, a user may input an entry representing and describing a checklist to be performed that is stored in memory. The checklist may comprise a sub-task that represents a portion of the checklist that needs to be performed. Sub-task data and its attributes may be stored in memory. Thus, a checklist may be made up of a series of sub-tasks having cohesive attributes assigned thereto that represent real world items or errands to be completed. A checklist may allow a user to organize many related sub-tasks into a single checklist, with each of the sub-tasks or sub-portions to be managed under a single task. Attributes may be applied to the data representing the sub-portions of the task in order to allow a system to keep the sub-portions associated with the project to which they belong. In the illustrated embodiment, CHECKLIST 1 has SUB-TASKS 1-4. A badge count may be a count of the number of sub-tasks associated with a project or task needed to complete the project or task. A badge count may comprise a plurality of portions. A portion may be dedicated to present the number of overdue sub-tasks within the task or project.

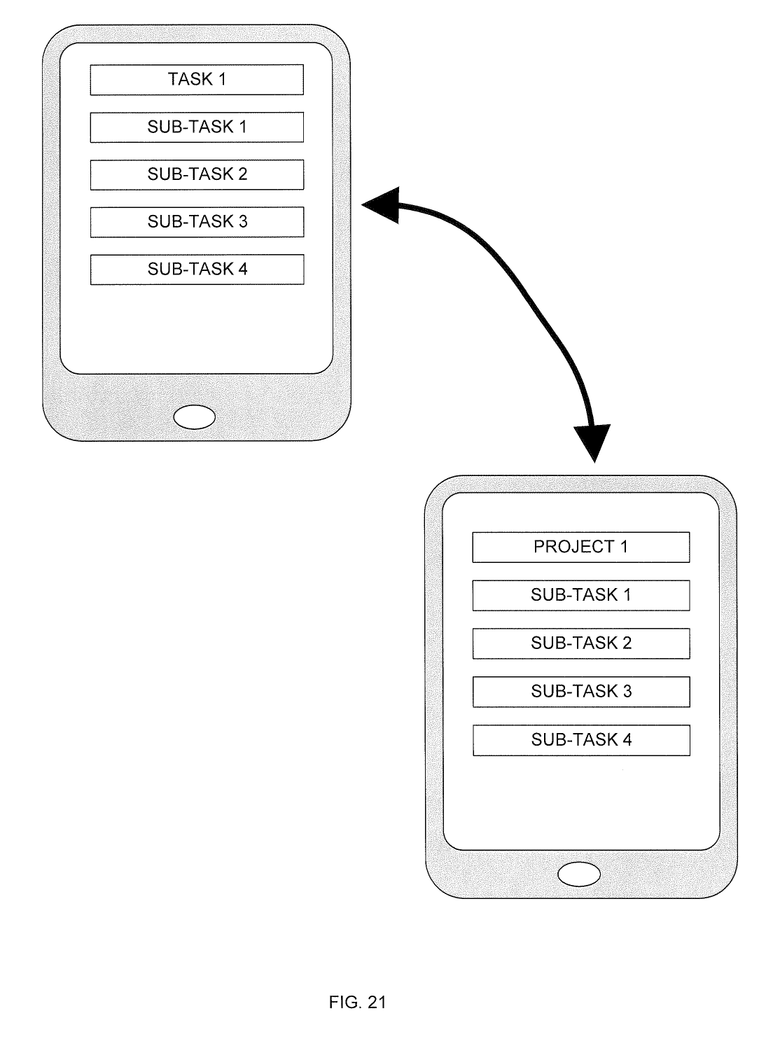

FIG. 21 illustrates a conversion between a task and a project. A task can be converted into a project. Conversely, a project can be converted into a task. As illustrated, the method may convert TASK 1 into PROJECT 1. For example, upon conversion, SUB-TASKS 1-4 of TASK 1 will become SUB-TASK 1-4 of PROJECT 1. It will be appreciated that the sub-tasks will be assigned the attribute and characteristic data of the other object type. For example, the sub-tasks of TASK 1, upon conversion to PROJECT 1, will be assigned the attribute and characteristic data of the PROJECT 1 and vice-versa.

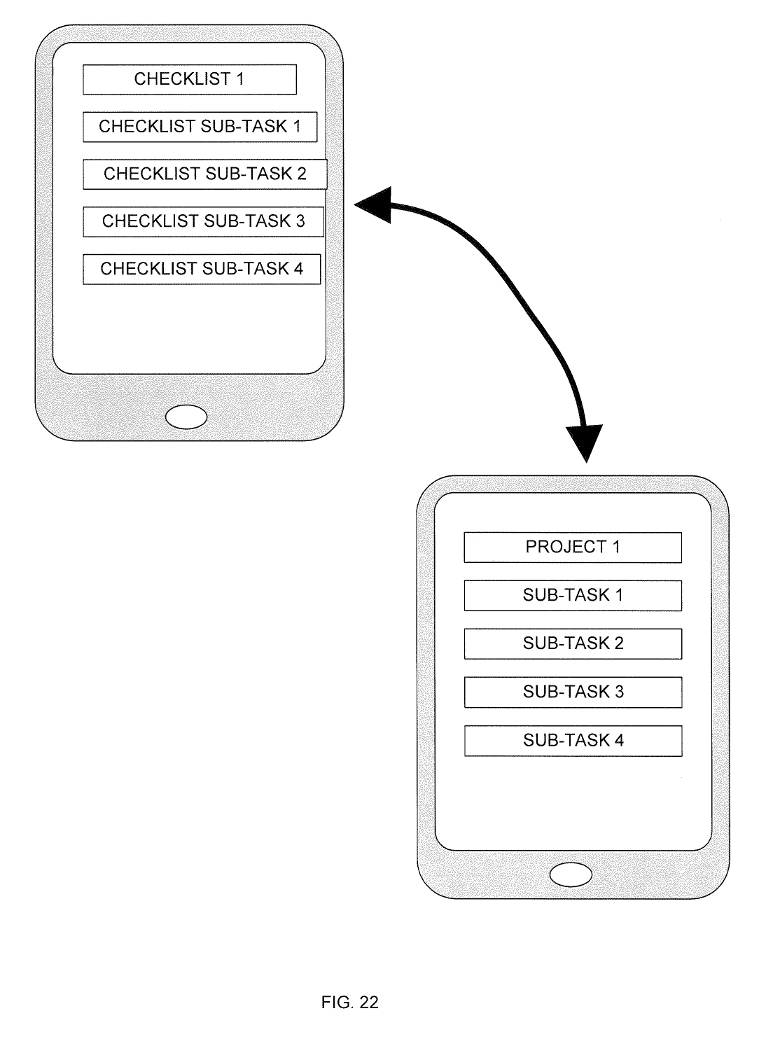

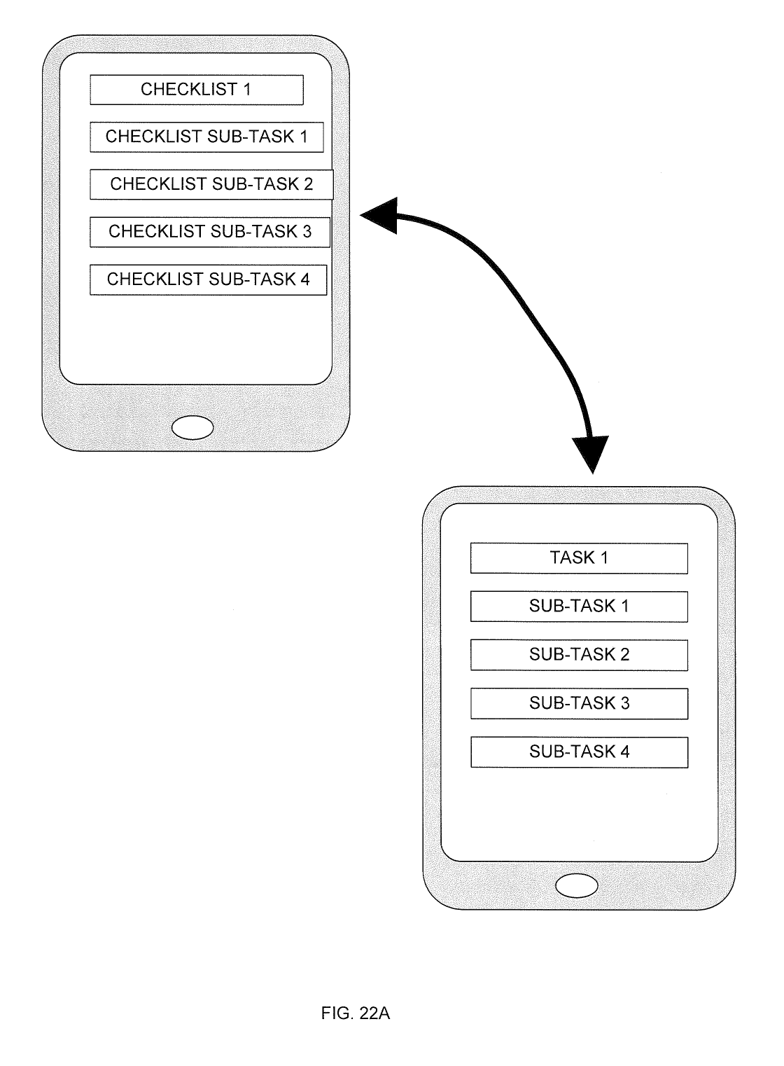

FIG. 22 illustrates a conversion between a checklist and a project. A checklist can be converted into a project. Conversely, a project can be converted into a checklist. As illustrated, the method may convert CHECKLIST 1 into PROJECT 1. Upon conversion, CHECKLIST SUB-TASKS 1-4 of CHECKLIST 1 will become SUB-TASK 1-4 of PROJECT 1. It will be appreciated that the sub-tasks will be assigned the attribute and characteristic data of the other object type. Checklist sub-tasks may not have all of the attributes of a project sub-task. In such a case, attribute data place holders will be created and assigned a predetermine value for storage in memory during conversion. In the instance when a project is converted into a checklist, non-supported attributes will be deleted from the sub-task attributes to accommodate for the limited attribute categories of a checklist sub-task.

FIG. 22A illustrates a conversion between a checklist and a task. A checklist can be converted into a task. Conversely, a task can be converted into a checklist. As illustrated, the method may convert CHECKLIST 1 into TASK 1. Upon conversion, CHECKLIST SUB-TASKS 1-4 of CHECKLIST 1 will become SUB-TASK 1-4 of TASK 1. It will be appreciated that the sub-tasks will be assigned the attribute and characteristic data of the other object type. Checklist sub-tasks may not have all of the attributes of a TASK sub-task. In such a case, attribute data place holders will be created and assigned a predetermine value for storage in memory during conversion. In the instance when a task is converted into a checklist, non-supported attributes will be deleted from the sub-task attributes to accommodate for the limited attribute categories of a checklist sub-task.

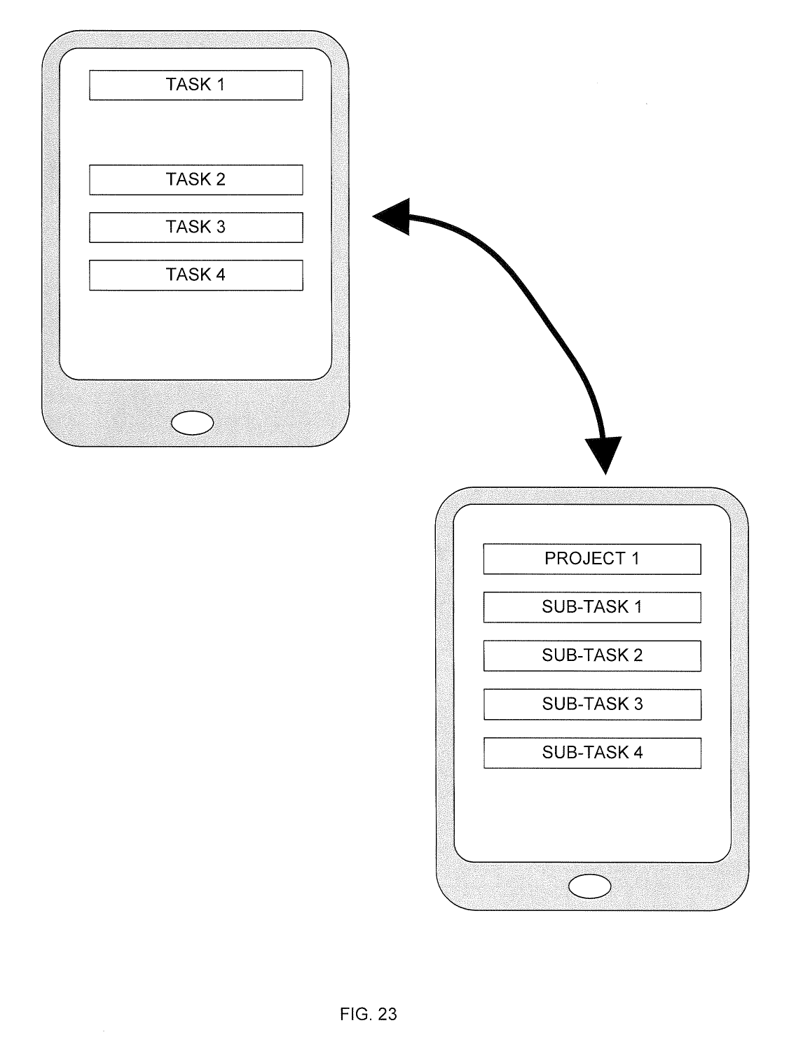

FIG. 23 illustrates a conversion between a task into sub-tasks and then assigning the sub-tasks to a project. A task can be converted into sub-tasks. Those sub-tasks may then be given project attributes and assigned to a project. As illustrated, the method may convert TASKS 1-4 into SUB-TASKS 1-4 and assigned to PROJECT 1. Upon conversion TASKS 1-4 will become SUB-TASK 1-4 of PROJECT 1. The sub-tasks will be assigned the attribute and characteristic data of the project and recorded and stored in memory.

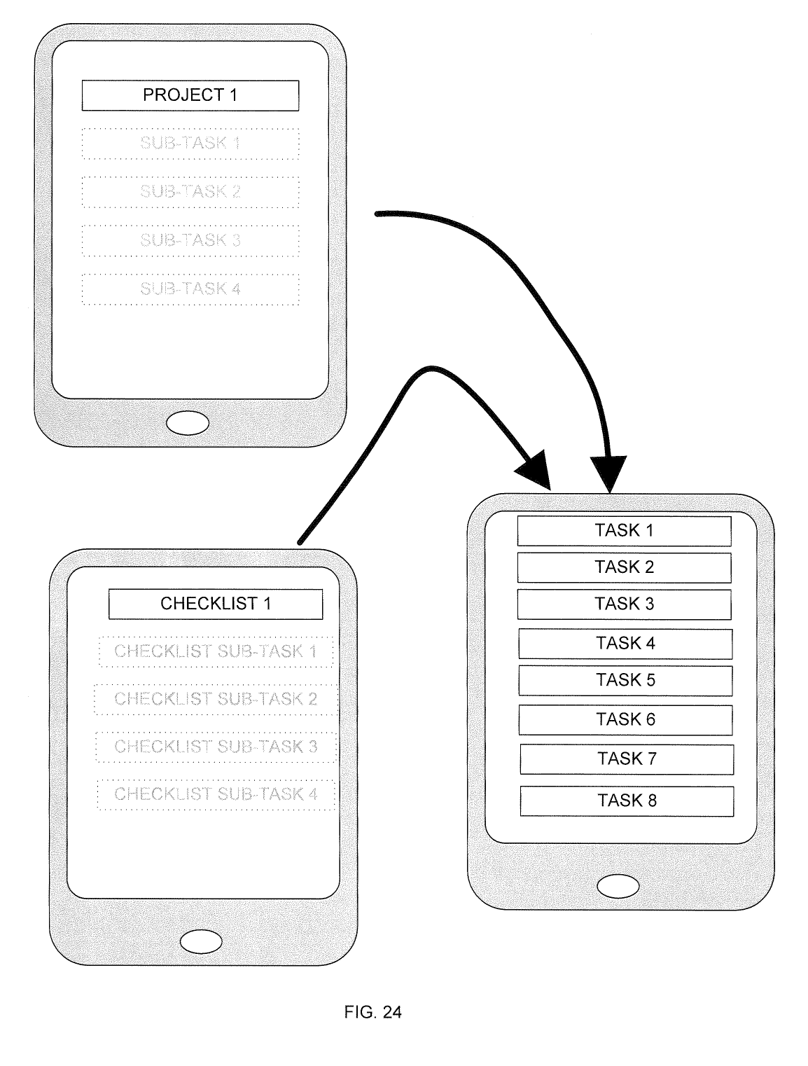

FIG. 24 illustrates a conversion from a checklist and project into tasks. A project can be converted into tasks. As illustrated, the method may convert PROJECT land its SUB-TASKS 1-4 into TASKS 1-4. Upon conversion SUB-TASKS 1-4 of PROJECT 1 will become TASKS 1-4. The sub-tasks will be assigned attribute and characteristic data of the other object type. As illustrated, the method may convert CHECKLIST 1 into TASKS 5-8. Upon conversion CHECKLIST SUB-TASKS 1-4 of CHECKLIST 1 will become TASKS 5-8. The sub-tasks will be assigned attribute and characteristic data of the other object type. Checklist sub-tasks may not have all of the attributes of a task. In such a case, attribute data place holders will be created and assigned a predetermine value for storage in memory during conversion. The sub-tasks of the projects and checklist may then be removed from the project or checklist as shown by being grayed out in the figure.

In the foregoing Detailed Description of the Disclosure, various features of the disclosure are grouped together in a single embodiment for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description of the Disclosure by this reference, with each claim standing on its own as a separate embodiment of the disclosure.

It is to be understood that the above-described arrangements are only illustrative of the application of the principles of the disclosure. Numerous modifications and alternative arrangements may be devised by those skilled in the art without departing from the spirit and scope of the disclosure and the appended claims are intended to cover such modifications and arrangements. Thus, while the disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

1. A method comprising:
presenting to a user a portion of an ordered collection comprising at least one of a group of tasks and a group of projects;
wherein said tasks comprise a set of user entries that correspond to a plurality of task data sets stored in machine readable memory;
wherein said projects comprise a set of user entries that correspond to a plurality of project data sets stored in machine readable memory;
wherein said projects may comprise tasks therein;
selecting one of the user entries as a selection;
recording and storing the selection in memory; and
automatically retrieving a corresponding data set from memory representing one of said user entries and presenting said data set.

2-16. (canceled)

17. The method of claim 1, wherein said ordered collection further comprises a checklist;
wherein said checklist comprises a set of user entries that correspond to a plurality of task data sets stored in machine readable memory;
wherein said checklist may comprise checklist sub-tasks therein;
selecting one of the user entries as a selection;
recording and storing the selection in memory; and
automatically retrieving a corresponding data set from memory representing one of said user entries and presenting said data set.

18-22. (canceled)

23. A method comprising:
presenting to a user a portion of an ordered collection comprising at least one of a group of tasks and a group of projects;
wherein said tasks comprise a set of user entries that correspond to a plurality of task data sets stored in machine readable memory;
wherein said projects comprise a set of user entries that correspond to a plurality of project data sets stored in machine readable memory;
wherein said projects may comprise tasks therein;
wherein said ordered collection further comprises a checklist;
wherein said checklist comprises a set of user entries that correspond to a plurality of task data sets stored in machine readable memory;
wherein said checklist may comprise checklist sub-tasks therein;
selecting one of the user entries as a selection;
recording and storing the selection in memory; and
automatically retrieving a corresponding data set from memory representing one of said user entries and presenting said data set.

24. (canceled)

25. The method of claim 23, wherein said tasks comprise sub-tasks that represent individualized portions of said tasks.

26. The method of claim 23, wherein said collection is a group of entries representing projects that comprise sub-tasks.

27. The method of claim 26, wherein said sub-tasks of said projects have all of the properties of a task, but they are assigned only to a project.

28. The method of claim 26, wherein said projects comprise characteristics selected from the group of: due date, priority, status, start time, due time, alert time and star.

29-43. (canceled)

44. The method of claim 1, wherein tasks are converted into corresponding projects.

45. The method of claim 17, wherein tasks are converted into corresponding checklists.

46. The method of claim 1, wherein projects are converted into corresponding tasks.

47. The method of claim 17, wherein checklists are converted into corresponding tasks.

48. The method of claim 25, further comprising converting project sub-tasks into corresponding tasks and assigning said tasks into a collection corresponding to said project.

49. The method of claim 26, further comprising converting checklist sub-tasks into corresponding tasks and assigning said tasks into a collection corresponding to said checklist.

50. The method of claim 27, wherein a project's sub-tasks are limited to checklist sub-task properties.

51. The method of claim 27, wherein checklist sub-tasks inherit default values when converted to sub-tasks.

52. The method of claim 1, wherein tasks that are converted to sub-tasks in a project are assigned to said project.

53. The method of claim 17, wherein tasks that are converted to sub-tasks in a checklist are assigned to said checklist.

54. The method of claim 1, wherein converted sub-tasks from a project are removed from the project it was assigned.

55. The method of claim 17, wherein converted checklist sub-tasks from a checklist are removed from said checklist it was assigned.

56. A method comprising:
presenting to a user a portion of an ordered collection comprising at least one of a group of tasks and a group of projects;
wherein said tasks comprise a set of user entries that correspond to a plurality of task data sets stored in machine readable memory;
wherein said projects comprise a set of user entries that correspond to a plurality of project data sets stored in machine readable memory;
wherein said projects may comprise tasks therein;
wherein said ordered collection further comprises a checklist;
wherein said checklist comprises a set of user entries that correspond to a plurality of task data sets stored in machine readable memory;
wherein said checklist may comprise checklist sub-tasks therein;
selecting one of the user entries as a selection;
recording and storing the selection in memory; and
automatically retrieving a corresponding data set from memory representing one of said user entries and presenting said data set.

57. The method of claim 56, wherein tasks are converted into corresponding projects.

58. The method of claim 56, wherein tasks are converted into corresponding checklists.

59. The method of claim 56, wherein projects are converted into corresponding tasks.

60. The method of claim 56, wherein checklists are converted into corresponding tasks.

61. The method of claim 56, further comprising converting project sub-tasks into corresponding tasks and assigning said tasks into a collection corresponding to said project.

62. The method of claim 56, further comprising converting a checklist into a project wherein checklist sub-tasks are converted into corresponding tasks and sub-tasks within a project.

63. The method of claim 56, wherein a project's sub-tasks are limited to checklist sub-task properties.

64. The method of claim 56, wherein checklist sub-tasks inherit default values when converted to sub-tasks.

65. The method of claim 56, wherein tasks that are converted to sub-tasks in a project are assigned to said project.

66. The method of claim 56, wherein tasks that are converted to sub-tasks in a checklist are assigned to said checklist.

67. The method of claim 56, wherein converted sub-tasks from a project are removed from the project it was assigned.

68. The method of claim 56, wherein converted checklist sub-tasks from a checklist are removed from said checklist it was assigned.

69. The method of claim 62, wherein place holding values are automatically assigned to attributes of tasks and sub-tasks, once converted from a checklist sub-tasks to tasks and sub-tasks within a project.

70. The method of claim 56, further comprising converting a project into a checklist wherein project tasks and sub-tasks are converted into corresponding tasks and sub-tasks within a checklist.

71. The method of claim 70, wherein attribute data is discarded during the conversion of project tasks and sub-tasks into checklist tasks and sub-tasks.
